(19) United States
(12) Patent Application Publication
(10) Pub. No.: US 2002/0199118 A1
(43) Pub. Date: Dec. 26, 2002

(54) Internet training course system and methods

(75) Inventors: James V. Yardley, Centerville, UT (US); Michael A. Wilson, Salem, UT (US); Gale H. Thorne, Bountiful, UT (US)

Correspondence Address: Paul S. Evans, MEDINSERVICE.COM, INC., 585 West 500 South, Bountiful, UT, 84010, US

(73) Assignee: MedInservice.com, Inc.

(21) Appl. No.: 10/057,336

(22) Filed: Jan. 23, 2002

Related U.S. Application Data
(60) Provisional application No. 60/265,962, filed on Feb. 2, 2001.

(51) Int. Cl. G06F 11/30

(52) U.S. Cl. 713/201

(57) ABSTRACT

This invention provides a secure method for developing, releasing and distributing training courses via the Internet. The method permits each browser of one or more personal computers to be modified from a central server to allow the computers to be used as training course development tools. The method provides unique modes of operational security over all phases of training course development, distribution and use which maintain privacy and protect individual interests of authoring clients, a server provider and student clients. Transmitted files are encrypted such that all confidential aspects of a training course under development remains private and totally under control of an authoring client until released by the authoring client. Training course development files are stored in encrypted format making contents of the training course development files inaccessible to server maintenance personnel and all others who do not have access to an associated private key for file decryption. In this manner, the training course service provider is relieved of pressures of unauthorized access to server based information and may therefore provide service to competitive authoring clients. The method provides similar security for a student client. A method is also provided for testing and verifying each training course while maintaining privacy prior to release.

### CROSS-REFERENCE TO RELATED APPLICATIONS

This patent application is a regular utility application claiming priority to U.S. Provisional Patent Application Serial No. 60/265,962, filed in the U.S. Patent and Trademark Office (USPTO) on Feb. 2, 2001 by Yardley et al., the entire contents of this application being hereby incorporated by reference herein.

### FIELD OF INVENTION

This invention relates to apparatus and methods by which training courses are developed and distributed over the Internet and particularly to courses such as medical inservice training courses and other training courses.

### BACKGROUND OF THE INVENTION

The Environment

The Internet probably represents the best universal training medium created in the history of mankind. Data and courses can be made immediately available from an educator located in almost any portion of the Earth to a recipient student nearly anywhere else. Training material for such courses can range from simple written format to detailed pictures, streaming video and synchronized audio. Translations are readily provided to overcome language barriers. Computer power associated with Internet transmission permits not only sequencing of pages of training material, but paging back and forth through a course sequence to review and extract information which requires selective review to commit difficult to retain material to memory. Still further, dynamic e-mail processes and video communications permit person-to-person communications where questions unanswered in course material may be addressed in a timely fashion. Finally, through two-way communications, training effectiveness may be tested automatically.

One of the more costly and common needs for training for which the Internet is directly applicable is inservice training (i.e.education, customarily supplied by and at the expense of a product provider) for products sold and used by a client of the provider. It is common practice for product providers to supply inservice training at the client's convenience and site, all at provider's expense. Generally, though not universally, medical inservice training is performed by sales representatives at significant expense to both the product provider and sales representatives, themselves, due to loss of time which might otherwise be spent in product selling. It is commonly reported that up to forty percent of a medical sales representative's time may be expended toward inservice training. From a vendee's viewpoint, such training may be severely limited by the amount of time a company representative may profitably spend at each vendee site. Such a conundrum is clearly solved by making quality inservice training available over the Internet.

However, the Internet, by itself, does not satisfy all of the problems associated with medical (and other areas of industry) training needs. Probably the greatest need for inservicing is found at the time of new product introduction. In medical practice, no clinician or technician should use a device before being trained, qualified and certified. Such training should be available concurrently with product introduction. It may be concluded, then, that a training course should be prepared, tested and qualified for each product and be ready for distribution at the time of product introduction.

Providing courses for product providers over the Internet is further complicated by a significant probability that each product provider is not likely to provide a server for its own inservicing courses. It is more likely that a third party provider would distribute Internet training courses through a server (server provider), acting as an internet training source for a client or individual who accesses the training. In such cases, there is a need by the product provider to keep all new product information confidential and secure from access, by any means, through the server provider until the product is introduced commercially.

Of course, keeping product and training course development information secret implies either training course development in-house or carefully controlled course development by another party. As it is likely that the third party provider will also serve a broad spectrum of other product providers, including potential competitors, protection against subversive acts of industrial espionage must be provided for both each product manufacturer as well as for the third party provider.

The need to protect against premature leaks of product information is not the only source of security required by the third party provider. To be successful, the third party provider must be a single source provider for training courses distributed through its server. For this reason, training courses sent by a product manufacturer for distribution by the server of the third party provider must be also protected from pirating by unethical accessors of training courses available through the third party server.

While training courses may be viewed as being superficial and somewhat frivolous in nature for those who are simply gathering product information, inservice training implies a need to assure adequacy of knowledge and understanding to use a medical or other high technology device under challenging circumstances. As an example, each health organization generally maintains a standard which requires certification of its technical and clinical personnel prior to permitting any new product use in its facility. For this reason, such health organizations may, at least under prespecified conditions, want to have a certification test program affixed to selected training courses. Security of such certification testing must also be maintained for privacy reasons as well as assurance of quality of the testing program. Further, each certification test program must be solely the property of the generating health care facility; only amended by the health care facility and all communications concerning certification testing must be kept private.

For a remote, prototypal personal computer of a prospective training course author, there is an underlying need to provide an Internet based training course development system whereby a service is provided from a centrally disposed server which modifies the personal computer to make the personal computer into an authoring tool work station. There is a complementary need to provide a student client with a similar authoring tool such that certification testing may be added to a training course generated by the training course author.

Definition of Terms

Devices and processes associated with the Internet have been given acronyms and abbreviations which are becoming commonly used. In the interest of communicating with standard terminology the following terms, some of which are found U.S. Pat. Nos. 5,708,780, 5,724,510, 6,006,268 and 6,012,088, are defined as follows:

| | |
|---|---|
| Assembler | Software for constructing (assembling) a logical sequence |
| | of course segments into a demonstrable course file or |
| | complete training course. |
| Author | One who writes a training course or certification test or |
| | other program which is resident as a client accessible |
| | course or a part of a course. |
| Browser | Usually referred to as a “Web” browser which is |
| | a form of client software used to display Web pages as |
| | well as traditional non-Web files. |
| CDROM | A compact disk read only memory. (May be replaced |
| | by a rewriteable compact disk.) |
| Client | A customer of a server provider who receives training |
| | course development material or training courses from |
| | the server provider. |
| CPU | An acronym for central processing unit. A CPU is a |
| | digital computer which may be a personal computer, a |
| | large computer or any other computer used to service |
| | computational, digital control or storage needs in a |
| | digital system. |
| Digital | A key to starting an SSL procedure, each digital |
| Certificate | certificate is generally issued by a Certificate |
| | Authority which amounts to issuing a public key |
| | exchange. |
| Facilitator | A program or set of programs which facilitate |
| | creating and testing ICP's FTP File Transfer |
| | Protocol |
| HTML | Hypertext Markup Language a language for |
| | formatting Internet transmitted pages, HTML |
| | includes standard text as well as |
| | formatting codes. |
| HTTP | Hypertext Transfer Protocol a protocol |
| | designed to run primarily over TCP/IP using |
| | standard Internet setup. |
| ICP | Inservice course programs |
| ICPO | ICP Originator, a client responsible for |
| | creating, testing, authorizing use and releasing |
| | for distribution each training course program. |
| ICPR | ICP Receiver, a client who receives and |
| | is taught by ICP's, the client may be an |
| | individual or staff of a facility inserviced |
| | via ICP's. |
| I/O | Input/output, usually references buses |
| | or devices which process data |
| | bidirectionally. |
| IDE | Integrated development environment |
| | usually associated with bus structure for |
| | locally disposed disk drives. |
| Internet | This term (with upper case “I”) |
| | refers to that particular global |
| | communications network that is in use around |
| | the world. |
| IP | Internet protocol |
| IP Address | Accessible address of a computer or other |
| | device attached to the Internet. |
| ISP | Internet service provider (telecommunication |
| | carrier) |
| Key | An encryption code |
| LAN | Local area network, generally considered to be |
| | capable of higher speed transmission |
| | than WAN's. |
| Network card | A network interfacing card which generally |
| | provides a unique identification |
| | address. |
| NIC | Network interface controller. |
| PC | Printed circuit (board). |
| PCI | A peripheral component interconnect usually |
| | used for a local bus. |
| PCI/IO | Expansion of PCI. |
| PGP | A trademark for a powerful cryptographic product |
| | family that enables secure and private |
| | transmission of messages over the |
| | Internet. PGP utilizes public/private key |
| | encryption and decryption processes. |
| PCMCIA | Interface port for laptop computers. |
| Plug and Play | A system which is used with all connecting protocol |
| | occurring transparent to a user. |
| Private key | A portion of an encryption code which is |
| | complementary to a given public key, |
| | and is the only key which may be used |
| | to decrypt information encrypted with |
| | the given public key, such a combination |
| | is commonly referenced as a public/ |
| | private key combination. |
| Proxy | A computer system which is disposed within |
| | a network to provide a firewall (security) |
| | to insulate another computer (protected) |
| | from potentially dangerous outside contact. |
| Public key | A portion of an encryption code (i.e a public/ |
| | private key combination) generally provided to |
| | those who send information coded by the public |
| | key to a receiver having a private key to |
| | decrypt that information. |
| RDRAM | Rambus dynamic random access memory (a form of |
| | dynamic random access memory) having a clock |
| | which is synchronized with an associated CPU |
| | clock and offers high speed data transfer |
| | rates such as those used for video accelerators. |
| SCSI | Small computer system interface which permits |
| | multiple peripheral devices to be connected to |
| | a host computer. |
| SDRAM | Synchronous dynamic random access memory which |
| | synchronizes an inherent memory clock with an |
| | associated CPU clock. |
| Server | A server is a computer connected to a network via |
| | a network card and is programmed to act as a |
| | traffic manager and storage device for data being |
| | transmitted over the network by various connected |
| | nodes. |
| Simulator | A device which enables a client to reproduce and |
| | experience under test conditions phenomena likely |
| | to occur in actual performance. |
| SSL | An abbreviation for “Secure Sockets Layer”, |
| | a name associated with securely tunneling or passing |
| | information over the Internet. |
| Student | A trainee of training courses received from the server |
| | provider. |
| TCP | Transmission control protocol |
| TCP/IP | A combination of the two best-known protocols of the |
| | Internet protocol suite which permits full use of the |
| | Internet. |
| Tool Shed | A file of keys coded with a public key of an authoring |
| | client such that a plurality of authorized authoring |
| | clients may have access to secured program files from |
| | which segments or portions of a total training course |
| | is developed. |
| URL | Uniform Resource Locator |
| USB | Universal serial bus usually associated with local |
| | peripherals communication (e.g. communicating channel |
| | for a digital camera of disk drives). |
| WAN | Wide area network, may be wireless. |
| World-wide | Denotes a method of using information on the |
| Web | Internet which allows a user to navigate Internet |
| | resources. |

### SUMMARY OF THE INVENTION

In brief summary, this novel invention alleviates all of the known problems related to authoring, qualifying and protecting proprietary Internet-based training courses. Inherent in the instant invention is a secure method for developing, releasing and distributing training courses via the Internet.

The method includes providing a client, who authors the training courses, release control and secure confidentiality of all contents of the training courses prior to authorized training course release by the authoring client. A previously authorized authoring client provides one or more computers having Internet links and associated browsers for communicating with a server of a predetermined service provider.

The service provider provides Internet sourced development programs from server-based storage. Included in the development programs selectively sent by the service provider to the authoring client over the Internet are all applets, plug-ins and other software programs necessary for reconfiguring each browser as a training course authoring tool. Also communicated to the authoring client computers are encrypting programs which permit selective encryption of all training course files generated on the client computers sent for assembly and storage to the server of the service provider.

During course development, files sent for storage on the server are encrypted such that only those authoring the training courses may have access to information contained in the courses prior to release for publication and no other person, including personnel at the server site, has access to such course information. In this manner, the training course service provider is relieved of pressures of unauthorized access to server based information and may therefore provide service to competitive authoring clients.

Release for publication of each training course is accomplished by passing a decryption key to the server. Selective control of released training courses publication and distribution is provided such that each training course, released for publication by the authoring client, can only be published over the Internet by the training course service provider.

A secret key (or a public/private key combination) is defined for and applied to each file stored on the server. In this manner, all training course development material is generated and then stored encrypted on the server such that the authoring client controls all access to the training course material during development. As individual segments or portions of training courses are developed, those segments or portions are transmitted to the server and stored encrypted for use only by the client authoring those segments or portions. Since it may be desirable to access files, programs, segments or portions from more than one computer by an authoring client, a secure method for passing a given encrypting key from an originating computer to an authorized user on another computer is provided. Further, because more than one person may cooperate in the generation of a given training course, and more than one author may use a particular file which is a segment or portion of a training program, a secure tool shed is provided whereby a plurality of authorized authoring clients have access to secured program files from which segments or portions of a total training course is developed.

In the process of training course (ICP) development, it is necessary to test and verify the course to simulate training as would be experienced by a student client (ICPR). As computers may receive data from servers at a variety of data rates, servers are programmed to provide run time programs at predetermined data rates to simulate expected variations in Internet transmission and reception.

Once a training course program has been qualified and a product announcement is schedule permitting publishing the training course, the training course is released for publication by transmitting the training course encrypting key (or keys) to the server. The training course is decrypted and reformatted as a “run-time” program for distribution to student clients.

To be useful in a student client enviromnent, a certification test is often required to assure quality of student training. In the same manner that an authoring client (ICPO) receives authoring tools and achieves security during training course development, a person generating a certification test for a student training facility (student client) receives authoring tools and achieves security for certification test development. Also, in a manner like that of training course development and release for publishing, a certification testing course is published by releasing a student client encrypting/decrypting (E/D) key set to the server.

In those cases where Internet communication rates or other communication properties make continuous communications with a server undesirable during training course development, a portable remote server is provided as a replacement for a connected Internet server. For continuing training course development, the portable remote server communicates with a centrally disposed server over the Internet to acquire all necessary files and programs to simulate the Internet server. Further, when a development session is completed with the portable remote server, results of the development session are communicated as encrypted files to the Internet server. As a complete replacement for the Internet server, the remote portable server also provides a variety of communication conditions for simulating training as would be experienced by a student client, as disclosed here before. In like manner, certification testing material may be generated and tested using a remote portable server.

Apparatus according to the invention comprises at least one authoring client computer having a browser and an Internet communicating link, a service provider server having an Internet communicating link accessible to the at least one computer, a server software package comprising applets, plug-ins and other programs for reconfiguring the browser to provide a training course authoring tool on the at least one computer for use by the authoring client and encryption and decryption programs by which all training course material composed by the authoring client is encoded to provide a secure encrypted file of all such course material sent to the server, storage capacity for encrypted files for the course material. Further, the server comprises software to decrypt course material files after receiving E/D key sets from the authoring client which authorizes publication of the training course and programs which provide “run time” programs for student clients. As an alternative, a remote server is provided for training course development where Internet service is not adequate for efficient file transfer. The apparatus comprises at least one student client computer having access to the server over the Internet. The student client computer may also have a browser which is adapted for training course file development for the purpose of providing certification testing.

Thus, in broad perspective, this invention inherently provides an Internet training course development system wherein an Internet server modifies a browser of a remotely disposed work station in communication with the server over the Internet to make the work station into an effective authoring tool. These modifications can be made for work stations for training course authors and for associated certification test authors.

Accordingly, it is a primary object to provide apparatus and method for developing, releasing and distributing training courses via the Internet which are published and distributed exclusively by an Internet service provider and which are authored by clients of the service provider.

It is another primary object to provide apparatus and method for developing, releasing and distributing training courses via the Internet which provide assured privacy, control and security to clients who author training courses and training course certification tests.

It is another primary object to provide apparatus and method for developing, releasing and distributing training courses via the Internet which provide for assured security for all authoring clients even when competitive clients are using the system provided by the Internet service provider.

It is a basic object to provide a secure method for releasing a training course by an authoring client for publication by the Internet service provider.

It is another basic object to provide apparatus and method for developing, releasing and distributing training courses via the Internet which deny access to sensitive training course development material-in-progress, from the server of Internet service provider, which is storing that material, to anyone but a person authorized by a client who is authoring that material.

It is a fundamental object to provide a browser based training course development and distribution system whereby an Internet service supplier provides a remotely disposed client Internet access to tools for developing training courses.

It is another fundamental object to provide a browser based training course development and distribution system whereby an Internet service supplier provides a remotely disposed client Internet access to tools for developing certification tests for associated training courses.

It is an object to provide apparatus and method for developing, releasing and distributing training courses via the Internet which provide a remote server which permits a work station to develop training courses off-line from the Internet, yet provides for eventual storage of training course material on the server of the Internet service provider.

It is an object to provide apparatus and method for developing, releasing and distributing training courses via the Internet which selectively provide student client access to a generic qualification test supplied by an authoring client for personalized qualification and certification test development.

It is another fundamental object to provide a training course development and distribution system comprising a computer-based work station of an authoring client upon which training courses are developed before release for distribution, and an Internet server of the Internet service provider, from which a browser-based training course development system is communicated to the work station thereby permitting the authoring client to develop training courses which are centrally recorded on the server.

It is an important object to provide a training course development and distribution system comprising a computer based work station, of an authoring client, upon which training courses are developed and released for distribution, and an Internet server, of a service provider, from which a browser based training course development system is communicated to the work station thereby permitting the authoring client to develop training courses which are centrally recorded on the server with full assurance for the server provider that the training courses will be accessible only from a server supplied by the service provider.

It is an object to provide an Internet based training course development and distribution system wherein an authoring client selectively controls student client access to courses prepared by the authoring client.

It is an object to provide an apparatus and method for securely developing Internet training courses utilizing a plurality of work stations, each work station being separately manned by those authorized by the authoring client.

It is an object to provide apparatus and method for developing, releasing and distributing training courses over a plurality of work stations, the work stations having selective access to a predetermined set of tools which are commonly available to those authorized by an authoring client.

It is an object to provide apparatus and method for developing, releasing and distributing training courses via the Internet which restricts access to published training courses to those students who are commonly authorized by authoring clients and student clients.

It is an object to provide apparatus and method for developing, releasing and distributing training courses via the Internet which provides protection against thievery of proprietary training courses published for student client use over the Internet.

It is an object to provide apparatus and method for developing, releasing and distributing training courses via the Internet which provide protection, against attack and modification by unauthorized agents, for training courses released for publication via the server of the Internet service provider.

It is an object to provide apparatus and method for developing, releasing and distributing training courses via the Internet which provide assembly for server based publication and use of training course material supplied by an authoring client.

It is an object to provide apparatus and method for developing, releasing and distributing training courses via the Internet which provide privacy protection for Internet based development and use of qualification and certification tests.

These and other objects and features of the present invention will be apparent from the detailed description taken with reference to accompanying drawings.

### BRIEF DESCRIPTION OF THE DRAWINGS

FIG. 1 is a block diagram of an exemplary system according to the invention herein disclosed for developing, releasing and distributing training courses via the Internet.

FIG. 2 is a block diagram of a computer based work station, of an authoring client, which communicates with a remote server for the purpose of operating in an off-Internet mode.

FIG. 3 is a block diagram of a computer based work station, of a student client, which communicates with a remote server for the purpose of operating in an off-Internet mode.

FIG. 4 is a graphic layout of an exemplary training course service provider web page.

FIG. 5 is a flow diagram showing web page provided selectable pathways to various application programs and an initialization phase of a training course authoring client computer program.

FIG. 6 is a flow diagram of a program which continues from the flow diagram shown in FIG. 5.

FIG. 7 is a flow diagram of a program which continues from the flow diagram shown in FIG. 6.

FIG. 8 is a flow diagram of a program which continues from the flow diagram shown in FIG. 7.

FIG. 9 is a flow diagram of a program which continues from the flow diagrams shown in FIG. 8.

FIG. 10 is a flow diagram of a program for test simulation of a training program which continues from FIG. 8.

FIG. 11 is a flow diagram of a program which continues from the flow diagrams shown in FIGS. 5 and 9 to delineate a remote server use pathway.

FIG. 12 is a flow diagram of a program which continues from the flow diagram shown in FIG. 5 to delineate a course development initialization pathway.

FIG. 13 is a flow diagram of a program which continues from the flow diagram shown in FIG. 12.

FIG. 14 is a flow diagram of a program which continues from the flow diagram shown in FIG. 13.

FIG. 15 is a flow diagram of a program continuing from flow diagrams shown in FIG. 9.

FIG. 16 is a flow diagram of a program which continues from the flow diagram shown in FIG. 15.

FIG. 17 is a flow diagram of a program which continues from the flow diagram shown in FIG. 16.

FIG. 18 is a flow diagram of a program which continues from the flow diagram shown in FIG. 5.

FIG. 19 is a flow diagram of a program which continues from the flow diagram shown in FIG. 18.

FIG. 20 is a flow diagram of a program which continues from the flow diagram shown in FIG. 5.

FIG. 21 is a flow diagram of a program which continues from the flow diagram shown in FIG. 5.

FIG. 22 is a flow diagram of a program which continues from the flow diagram shown in FIG. 21.

FIG. 23 is a memory layout for a key matrix for a tool shed which provides access to training course authoring tools.

FIG. 24 is a key matrix for a tool control file.

FIG. 25 is a key matrix for a training course segment file.

FIG. 26 is a matrix wherein public keys of public/private encrypting key combinations are stored.

FIG. 27 is a block diagram of a state-of-the-art server.

FIG. 28 is a block diagram of a remote server.

### DETAILED DESCRIPTION OF THE INVENTION

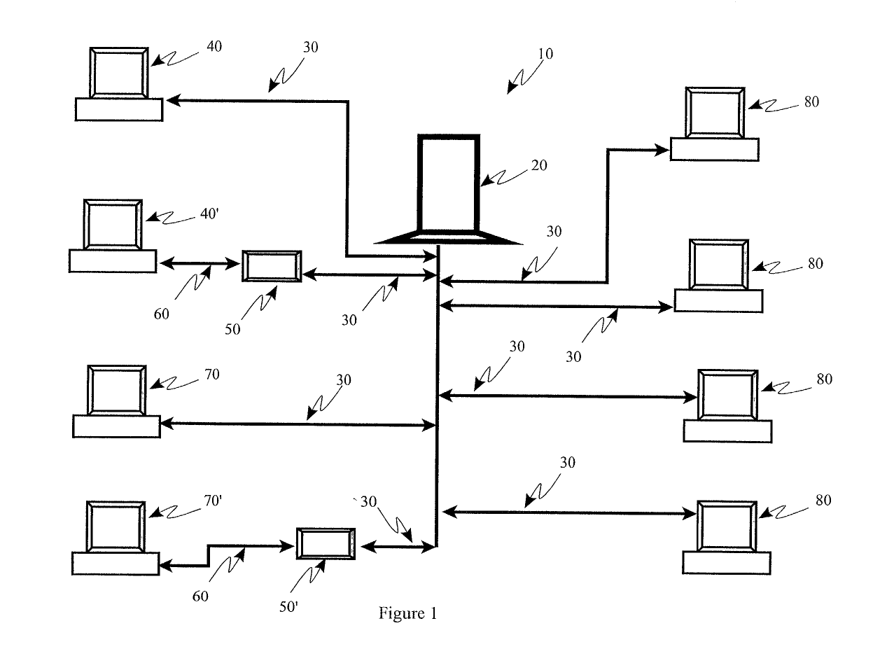

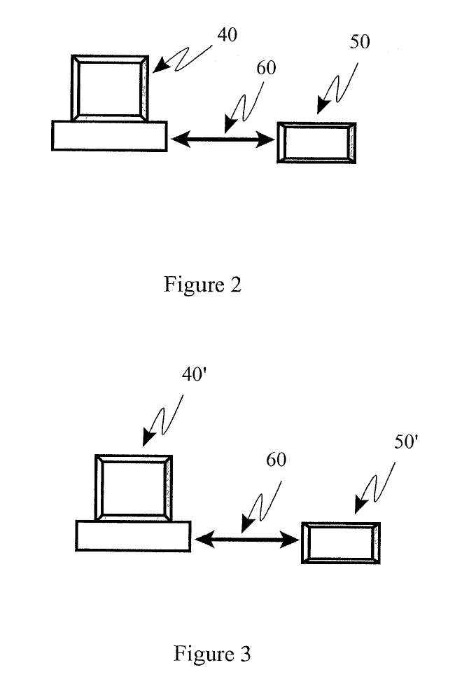

In this description, the term proximal is used to indicate the segment of a logical function or device normally closest to the object of the sentence describing its position. The term distal refers to an oppositely disposed segment of the device. Reference is now made to the embodiments illustrated in FIGS. 1-28 wherein like numerals are used to designate like parts throughout. In those cases where a second part performs a function similar to that of a first part, and is substantially identical in structure relative to the first part, a prime of the number assigned to the first part may be used. Double primes likewise may be used for third parts having similar structure and function to first and second parts.

Reference is now made to FIG. 1 wherein an exemplary system 10 is shown in block diagram format. System 10 comprises at least one server 20 of a service provider. Server 20 has access to the Internet over a plurality of communicating links and internet service providers (ISPs), generally numbered 30. A computer based work station 40 represents one or more Internet accessing ports for an authoring client. Work station 40 may be a personal computer or another computer capable of communicating over the Internet. System 10 may also comprise additional work stations, such as work station 40′ which is interfaced through a direct connecting link, generally numbered 60, to a remote server 50. Remote server 50 communicates with server 20 through an Internet link 30. Form and function of remote server 50 is disclosed in detail hereafter.

Another computer based work station 70 represents one or more Internet accessing ports for a student client. Work station 70, like work station 40, may be a personal computer or another computer capable of communicating over the Internet. Additional work stations, such as work station 70′, may be interfaced through a direct communicating link 60 to another remote server 50′.

Those work stations disposed on the left in FIG. 1, i.e. work stations 40, 40′, 70 and 70′, are generally used in the production of material related to training courses. Work stations, generally numbered 80, which are disposed on the right in FIG. 1, represent work stations dedicated to training students. Generally work stations 80 are personal computers or other computers capable of receiving information via communicating links and ISPs, also numbered 30, from server 20 and interactively receiving and transmitting training course related information from and to the server 20. Training course information is generally relayed from server 20 in a “run time” mode to reduce the likelihood of replicating and thereby pirating a training course by accessing a training program and performing a simple recording process.

As work stations 40, 40′, 70 and 70′ may have limited storage capacity, server 20 receives and stores portions of training programs as they are developed. It is critical to authoring clients that privacy of all such information sent from a work station 40, 40′, 70 or 70′ be strictly maintained. As it is understood that property of an authoring client may be worth millions of dollars and that competitors of the client may engage in industrial espionage, security of information contained in all files and other documents sent from work stations of the client over the Internet to server 20 must be held in secrecy until released by the authoring client for publication and other use by the service provider.

That security and privacy must prevail over all individuals not authorized access by an authoring client, including all personnel of the service provider. Further, for a service provider to offer development and publication of training courses as a viable business, system 10 must provide complete assurance that training course development made available via server 20 can only be used via server 20 or another server acceptable to the service provider.

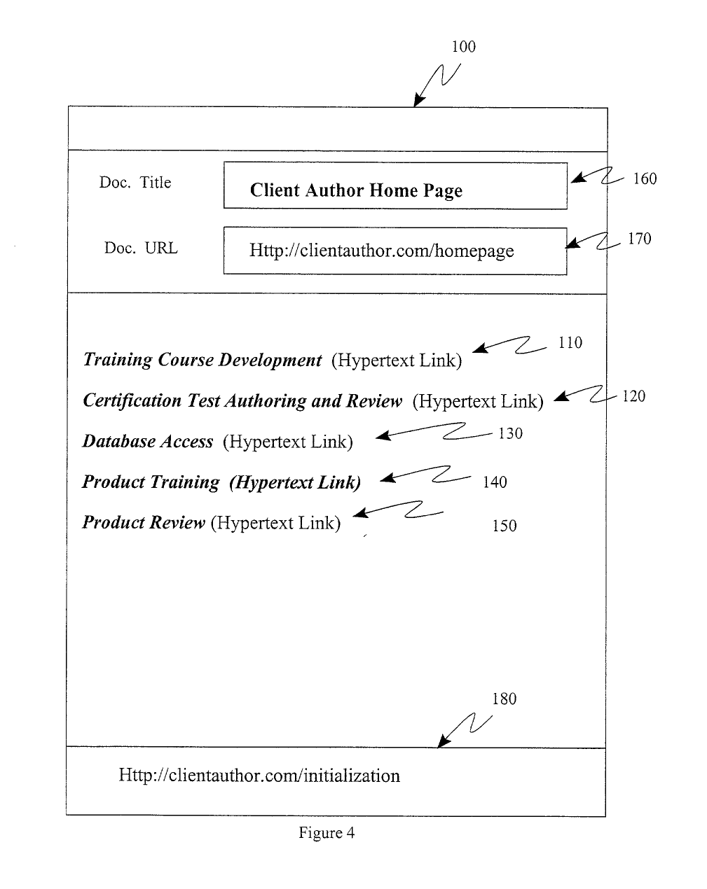

To reduce the number of clicks necessary to access server 20 from a work station 80, a web page, of which web page 100, shown in FIG. 4 is an example, provides a plurality of choices or paths offered by the training course service provider. Web page 100 offers choices comprising hypertext links to TRAINING COURSE DEVELOPMENT 110, CERTIFICATION TEST AUTHORING AND REVIEW 120, DATABASE ACCESS 130, PRODUCT TRAINING 140 and PRODUCT REVIEW 150. Of course, information concerning document title found in Doc. Title box 160 and URL box 170 may be varied to indicate service provider identity preference. Hypertext transfer protocol web page indication is found in HTTP box 180.

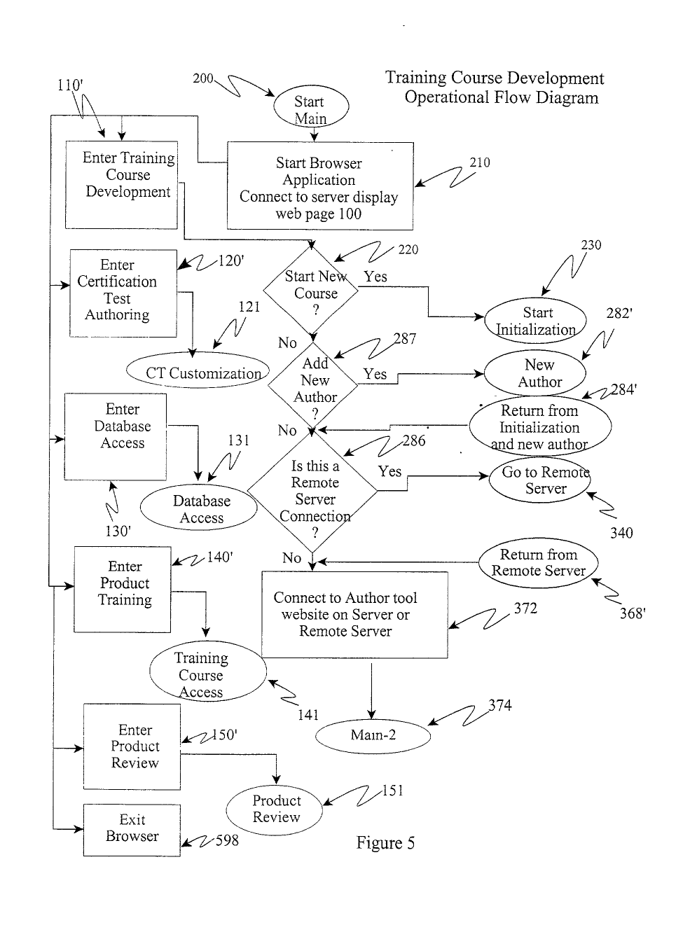

FIGS. 5-22 comprise flowcharts which diagram steps and processes associated with developing, releasing, publishing and distributing training courses according to the present invention. In the flowcharts, an ellipse or oval represents a point of entry into a routine or a link to another flowchart. Because points or links may occur in pairs, a first or originating point or link of each such pair is assigned a given reference number and a second or target point or link of that pair is assigned a prime of the given reference number. A rectangle represents a process and a parallelogram or diamond shape represents a decision. While decisions are generally binary (i.e. yes/no), some decisions may be multiple choice and may be selected from an array of icons or buttons on a web page.

Initial access to a server 20 of a training course service provider is via addressing a hypertext web page such as web page 100 by a requestor through a work station, such as through a work station 40, 40′ 70 or 70′. Note that, at this stage, the requester may not be a client. Such access may be open to anyone on the Internet, providing opportunity for advertisement of wares of the service provider and, as deemed appropriate, products of clients of the service provider. Therefore, beginning at entry point 200 (see FIG. 5), an Internet request is forwarded via process 210 through a browser communication to a URL of the web page of the service provider. Process 210 continues, with a connection to server 20 of the service provider, thereby providing a response comprising presentation of web page 100 on the computer display of the requesting client. Note that a requesting client may not be authorized to access the training course development system of the service provider.

It is anticipated that a sales contact, either through a salesperson or through an Internet transaction provides an authorization code for clients who are thereafter authorized to use the training development system of the service provider. In such a case, an authorized client can select the Hypertext Link to Training Course Development 110 to enter training course development initialization process 110′. As shown in FIG. 5, selection of Training Course Development 110 leads to decision block 220 where a “yes” decision, regarding starting a new course, leads to Start Initialization entry oval 230.

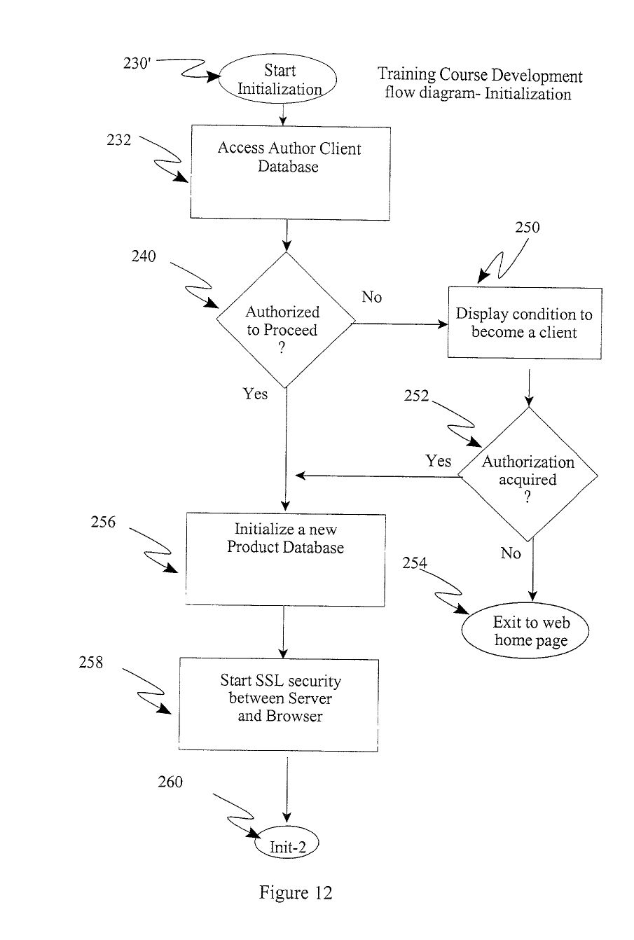

As shown in FIG. 12, process flow continues from oval 230′ to process 232 where access is made to an Author Client Data Base. A previously authorized client may be properly identified through the use of a login code or other biometric method, such methods being well known and widely used in contemporary computer art. At decision 240, an authorization to proceed is determined to assure that entry is only allowed to an authoring client who has been previously processed and authorized to use the system of the service provider. Generally, authorization is acquired through entry of a login code, although other forms of biometric or smart card identification may be used within the scope of the invention.

If continuing access is not authorized, the next step is process 250 by which a new access code or other identification is acquired or an indication of “no access” results. Generally, there are two cases where a resolvable “no access” situation occurs for a previously authorized client. These cases comprise a miscommunicated identification due to a forgotten login code, or the like, and a desire to become a new client. Procedures for recovering lost or forgotten identification are well known in the Internet identification art and will not be further addressed herein. If the request is made by a prospective client, a contract or agreement is made between the service provider and requestor and a new login code or other biometric identification is provided to the new client. If the need for authorization is not resolved, the next step is to exit oval 254. Generally, exit oval 254 may return to web page 100 where some opportunity is provided for unauthorized access to limited information, such as via Product Review Hyper Link 150, which may provide client sponsored advertising.

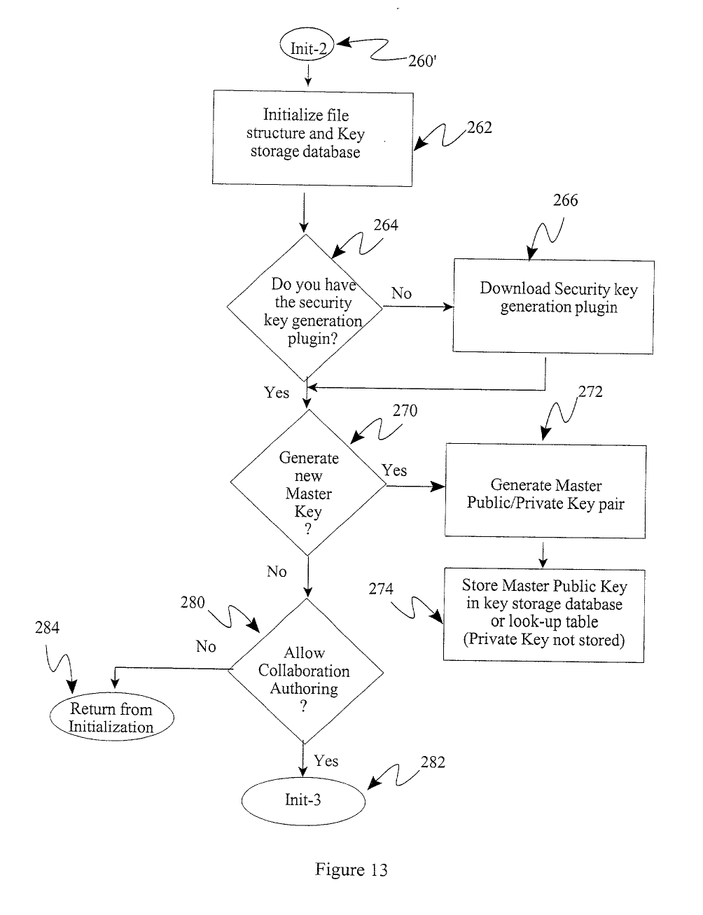

If a new access code or other identification is authorized and acquired or if decision 240 is “yes”, the requestor is now determined to be an authoring client permitting advancing to process 256 which establishes a data base for a new product training course about to be developed. The next step is process 258 wherein SSL security is established between server 20 and a work station 40 of the authoring client. As a part of the SSL security, the browser of the authoring client is supplied with a public encryption code of the service provider. An icon indicating that secure transmission has been established is displayed on work station 40. Following process 258, flow sequence continues through link 260 to link 260′ as shown in FIG. 13.

The first step in FIG. 13 is process 262 where file structures and data bases for the new product training course are defined, stored on server 20, with appropriate indicators and references being sent to the browser of work station 40. Critical file structures and data bases are disclosed hereafter in detail.

If work station 40 has been previously used for training course development by an authoring client, a number of training course routines and programs may be already stored in work station 40 for selective access by a browser modified to run the training course development program supplied by server 20. In that case, the availability of needed stored programs on work station 40 is simply noted by communication with server 20 and not resent to save time. For the purpose of making this determination, decision 264 only requires downloading of a security key generation plug-in to work station 40 for use of the browser, therein, when such is not already available. When necessary, process 266 downloads the security key generation program plug-in. The security key plug-in is a critical program of the invention. It is by the security key plug-in that a secure public/private key is generated by the authoring client. That key is critical to retaining privacy by the authoring client through training course development and until release of a training course for publication by server 20. One method of generating the authoring client public/private security key is through the use of a PGP security key defining program. Though other methods for defining security keys may be used, it is critical to note that the likelihood of attack should be considered when selecting any security defining system.

As this current authoring client is the original requester of the training course being initiated, the authoring client decides whether or not a new Master Key is to be generated in decision 270. Note, that at least one Master Key must be available. If a new Master Key is desired or no Master key exists, decision 270 leads to processes 272 and 274 where a new Public/Private Master Key pair is generated and stored. Note that the public key portion of the Master Key is stored in server 20 and in work station 40 where it is available to the browser of work station 40. Also note, that the private portion of the Master Key is strongly recommended to be available only in the mind of the original requestor (authoring client) to assure maintenance of security and privacy of training course material in all phases of training course development for the authoring client.

As may be the case for complex and high priority training course development projects, more than one work station 40 (40′) may be used involving multiple authors who serve the authoring client. Decision 280 permits branching to oval 282 (and linking to oval 282′) to add additional authorized authors. If no additional authors are desired at this time, oval 284 links to oval 284′ and therefrom to decision 286 (see FIG. 5). Note that a decision 287 permits changing author files without going through all of initialization via oval 230.

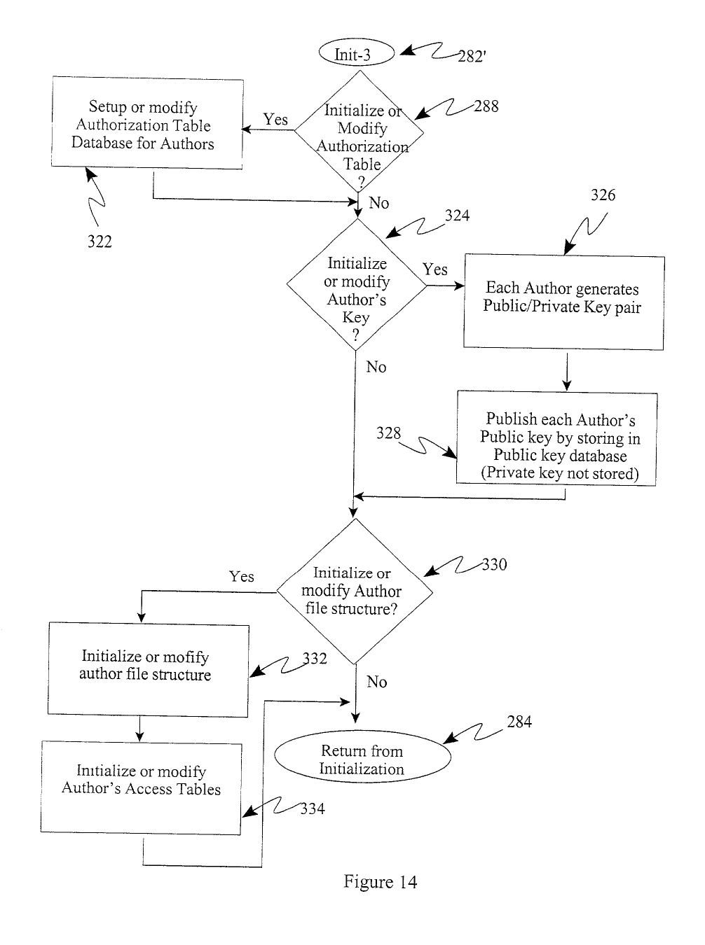

Oval 282′, shown in FIG. 14, links to decision 288 which determines whether or not an authorization table has been created or needs to be modified for those multiple authors currently scheduled to be authorized to take part in authoring portions of this training course development. Having multiple authors working separately in environments which may be widely separated physically or geographically presents a special control condition for system 10. Each author must have control of his own work product, yet, for efficiency, selected authors must have access to those portions of work products, of other authors, which should be included into work product of that author.

To permit each author to retain selective control of each assigned portion or segment of a training course, a public/private key combination is effectuated for that author. General access to the public key of the combination is generally made available to other authors via a key storage array 290, shown in FIG. 25. Array 290 is likely a 1×n array, having a single column P, although more columns may be used for multiple encrypting/decrypting key combinations use by individual authors. As is well known in the art of encryption and decryption, public keys may be made widely available without undue concern about retaining protection of privacy. For this reason, public codes are stored without encryption.

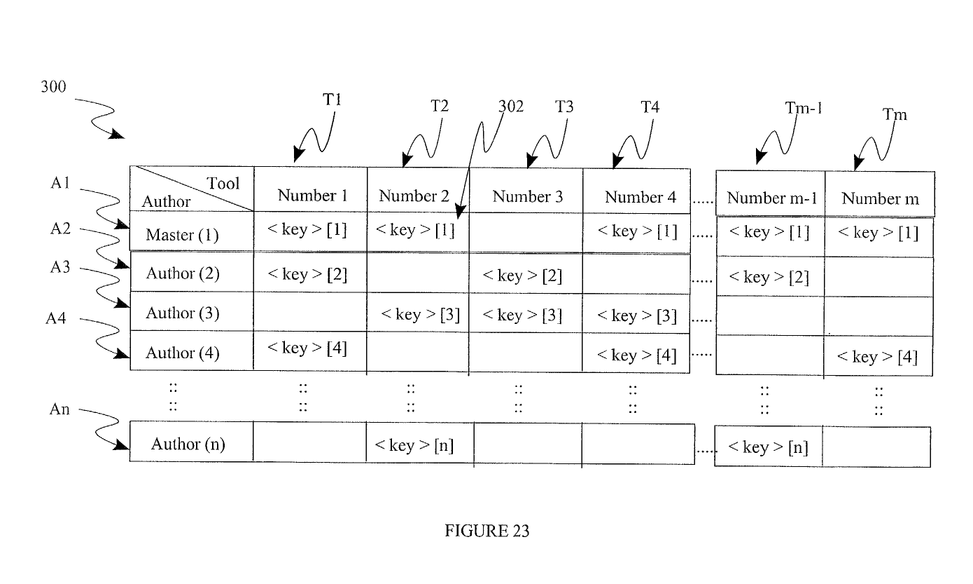

Those files which may be generally accessed for use by multiple authors are referenced as “authoring tools”. For ease of reference a file containing selectively available authoring tools is called a “tool shed”. A sample of a tool shed 300 is shown in FIG. 23. Tool shed 300 comprises a matrix having rows A1 thru An and columns T1 tbru Tm, one row being dedicated for each author and one column being dedicated to each tool. For each author and each tool there is a tool compartment, generally numbered 302 (see, for example compartment A1/T2), in which reference information is stored for that associated tool. In each tool compartment 302 (e.g. A1/T2) of tool shed 300, an encrypted key, encrypted by a public key of an author authorized access to the associated tool or file, is stored. As well, tool shed 300 preferably contains similarly encrypted reference titles for display on a web page and hypertext links to the tools themselves in each compartment 302. All tool files accessed by keys found in tool shed 300 are “run time” files, i.e. contents found in files accessed via tool shed 300 may be run, but not edited.

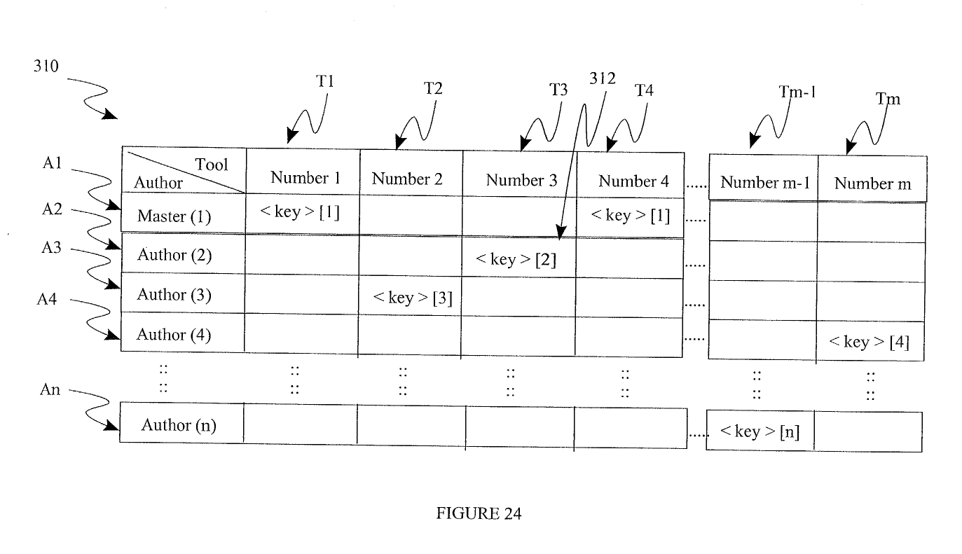

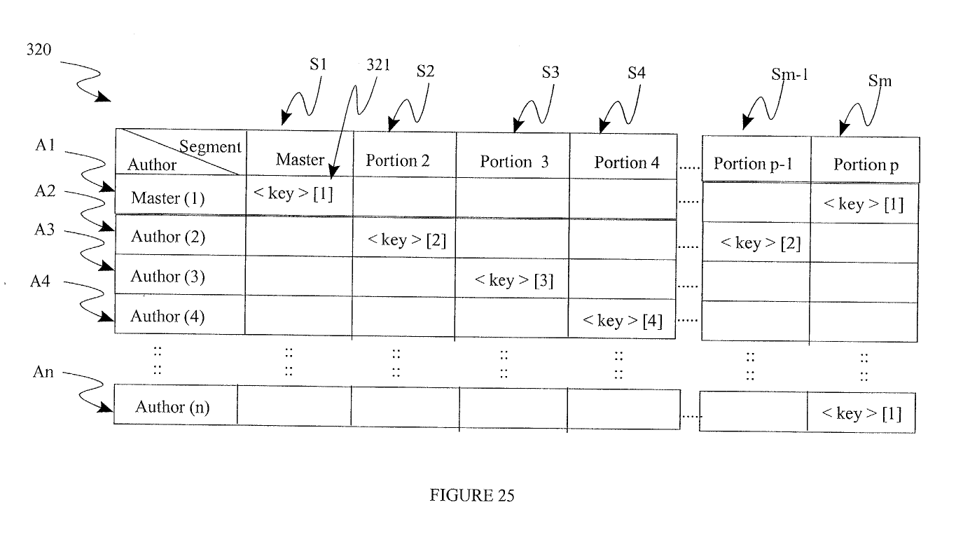

A second file, a tool control file 310 is shown in FIG. 24. Although tool control file 310 could be created as an “n” by 1 matrix, it is shown as a matrix having the same number of rows and columns as the matrix of tool shed 300, shown in FIG. 23 for simplicity of presentation. For this reason, tool control file 310 has rows A1 thru An and columns T1 thru Tm. As shown in FIG. 24, only one cell, generally numbered 312 (e.g. cell A2/T3), is filled in each column. That cell (in this example A2/T3) holds an encrypted secret key for basic programming code for the tool (T3) associated with that cell (A2/T3). Similar to compartment 302, cell 312 may also hold an encrypted reference title and appropriate hypertext link. In simple terms, it is highly preferable that only one author be permitted to modify and release any given tool at a particular time. The basic code for tool T3, in this example, is stored encrypted by a secret key defined by author A2. The basic code encrypting key is, itself, encrypted with the public code of author A2, thus assuring that only author A2 has access to the basic code of T3 and can thereby modify or edit the program associated with tool T3. Authorization to modify or edit a tool, such as tool T3, may be transferred from one author to another by transfer of the private key of a first author, e.g. author A2, to another author by encrypting the basic code with a public code of the other author.

Similarly, each segment or portion of a training course which is under control and being developed by a given, previously authorized author should remain under control of that author until that author releases control to another author, who is usually positioned higher on a development ladder than the given author. For this purpose a segment or portion file, shown as array 320 in FIG. 25, provides a record of control of each such segment or portion. Note, that author A1, as master author has the private key to segment or portion S1, with the public key being stored in a cell, generally numbered 321 (e.g. cell A1/S1). When a segment or portion is released by a given author for assembly into another segment or portion, the key for that segment or portion is changed and the segment or portion is recorded with a public key of the author to which control is being transferred. Note, in the case of segment or portion Sp, the stored key is <key>[1], indicative of a transfer of control to A1 (or master author). Similar to compartments 302 of Array 300 and cells 312 of array 310, each cell 321 also contains an encrypted reference title and hypertext link.

If there is need to modify the numbers of authors, decision 288 branches to process 322. Process 322, shown in FIG. 14, reconfigures row structure of arrays 290, 300, 310 and 320 to represent changes in number of authors, see FIGS. 26, 23, 24 and 25, respectively.

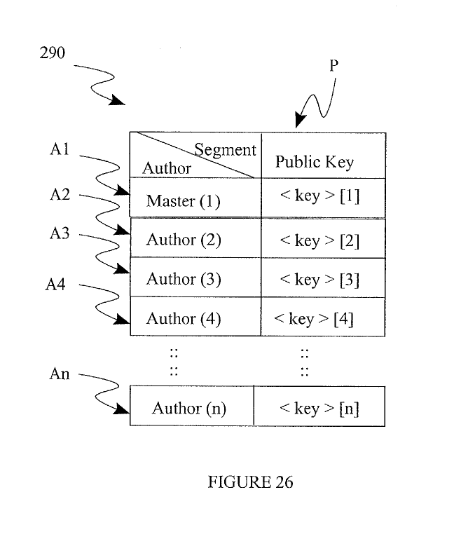

After process 322, the next step is decision 324. Should there be a need to initialize one or more authors keys, program flow proceeds to process 326 and therefrom to process 328. Via process 326 new public/private key combinations are generated (using, as an example commercially available PGP key generation procedures). Public keys are stored in array 290, shown in FIG. 26, of a data base in server 20 and thereafter made available to each authorized author accessing files for this training course. Note that private keys are not stored, but are retrieved from an author each time the author enters the training course development program. Retrieval may be through entry of a login code, but preferably through a more complex key development protocol, such as a protocol used for PGP key generation. PGP key generation may be based upon a series of questions which only the author can answer correctly.

Decision 330 is the next step following process 328 or upon a decision not to initialize or modify a key of an author at decision 324. Once a public key is available for each new author or a new key is available as part of a key change process, access codes as shown in FIG. 23 are modified to provide selective access to tool shed 300. As appropriate, when author structure is being initialized or modified, decision 330 leads to process 332. Process 332 defines or redefines tool shed 300 access. For each author authorized access to a particular column, T, of tool shed 300, a key to the file associated with that column is encrypted and stored in the compartment 302 in the row of the authorized author and in the column of that particular tool.

Process 334, following process 332, records assignment of a particular author to produce a given portion or segment of the training course under development for which this pass through initialization is being made. For this purpose, cell information of a cell 321 is provided for each new author or new segment or portion assignment (e.g. <key>[2] of author A(2) in column Sp-1 of FIG. 25).

If no array modification is required at decision 330 or upon completion of process 334, program flow continues through oval 284 (shown at the bottom of FIG. 14) to oval 284′, shown in FIG. 5. Upon return from initialization or if there is no change in authorship, decision 286 permits a determination of whether or not a remote server 50 is to be used rather than an Internet connection to a server 20.

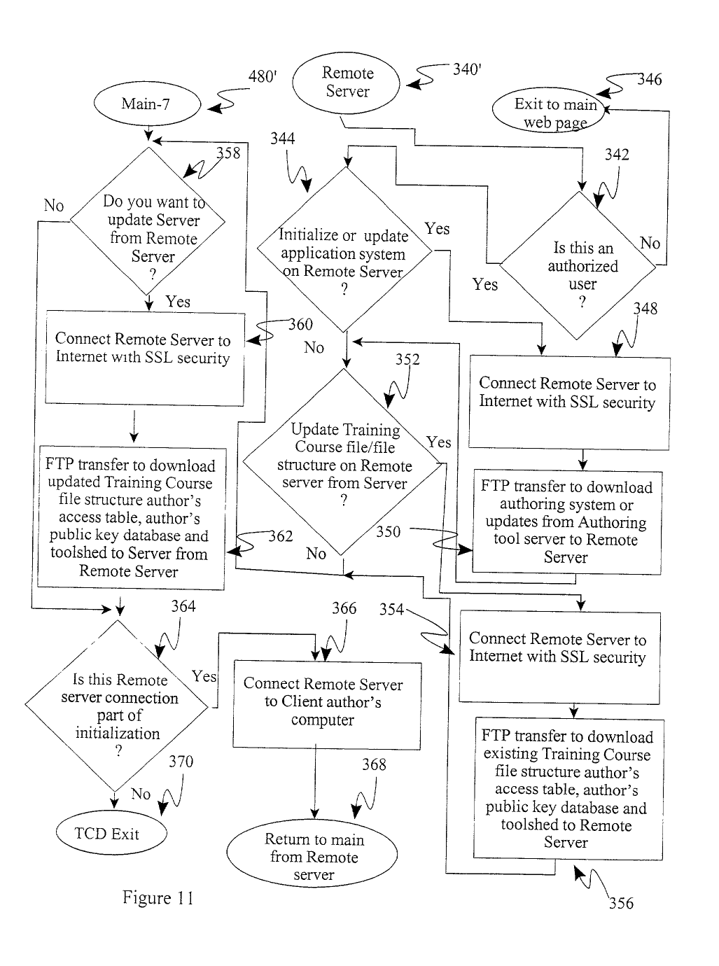

If a remote server 50 is to be used, program path is linked through oval 340 to oval 340′, shown in FIG. 11. Before using or changing to a remote server 50, authorization for such use or change is determined at server 20 by decision 342. There are many ways to make such a determination, but a secure way is to encode a secret message with a public key of a requesting author and sending the encrypted secret message to work station 40 of author through remote server 50. The requesting author simply decrypts the encrypted secret message and returns the decrypted message to server 20. If a proper decrypted message is received at server 20, the next step is process 344.

If the decrypted message is incorrect, the browser of this work station 40 is returned to Web page 100 via oval 346.

As a remote server 50 may need to be updated from time to time, a “yes” response to a query regarding need to update server 50 at decision 344, proceeds to process 348. Process 348 connects remote server 50 through the Internet links 30 to server 20. SSL security is established between remote server 50 and server 20, and next process 350 downloads necessary authoring system tools and updates to remote server 50.

Upon completion of process 350 or if no initialization or update is needed, the next step is decision 352. If tools and program segments associated with a particular training course to be worked on are not contained in remote server 50, decision 352 directs flow to processes 354 and 356. Process 354 connects remote server 50 through Internet links 30 to server 20 and establishes SSL security. Under that security link, all necessary training course files are transferred via FTP in encrypted format to remote server 50 via process 356. Files which are subject to transfer are those associated with arrays found in FIGS. 23, 24 and 25, including tool shed 300, tool control file 310 and training course portion or segment control file 320. Upon completion of process 356 or, in the alternative, if no update of training course file structure is required at decision 352, program flow proceeds to decision 358.

While use of remote server 50 may not involve an Internet link 30 to a server 20 a majority of times a remote server 50 is used with a work station 40, ultimately the product of all work performed on remote server 50 must be transferred to server 20. Decision 358 deals with that situation. All files from remote server 50 are transferred as encrypted files via FTP to the server as a result of a determination to transfer at decision 358. To accomplish the transfer, an SSL based connection is made to server 20 via an Internet link 30 (process 360). It is important to note that, as such, these files are doubly encrypted during transfer. Using FTP, process 362 selectively transfers all necessary files in encrypted format to server 20. Such files include changed training course segments or portions generated using remote server 50, new training course tools, and updates to tool shed 300 and to tool control file 310.

Upon completion of process 362 or if no server 20 update is determined necessary at decision 358, program flow continues to decision 364. If entry is via remote server oval 340′, decision 364 determines that remote server 50 is connected to associated work station 40 (via a direct communicating link 60) by process 366. Return to main program from remote server flowchart of FIG. 11 is through oval 368. If entry to flowchart of FIG. 11 is not by way of oval 340′, exit is through training course development (TCD) exit 370.

Note that it may be preferred to address decisions 342, 344, 352, 358 and 364 as hypertext links on a web page, with links by yes decisions associated processes and returns to that web page upon completion of the associated processes. In that case, exit ovals, (i.e. ovals 346, 368 and 370) would preferably be hypertext links as well.

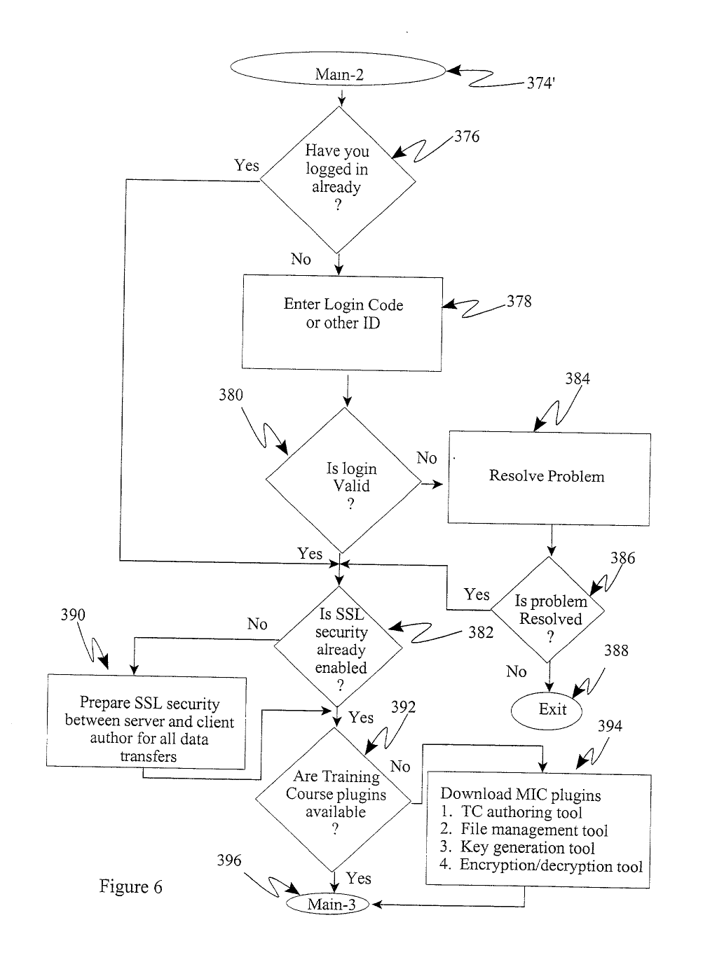

Upon return from remote server flowchart (FIG. 11) via oval 368′ or if no remote server connection determination is made at decision 286, process 372 (see FIG. 5) makes a connection to an authoring tool website via server 20 or remote server 50. From process 372, flow continues to FIG. 6 via linking ovals 374 and 374′. Note that, as was the case for decisions 342, 344, 352, 358 and 364 of FIG. 11, decisions 220, 287, 286 (and process 372) may be addressed individually as selectable hypertext links to reduce mouse or key operations.

First level of access authorization is permission via a simple biometric identification, such as entering a login code. Decision 376 determines whether or not an authoring client is already logged in. If not, a login is requested (process 378). A check of an entered login code is made (decision 380) and, if the entered login code is valid, flow continues to decision 382. If the entered login code is not valid, corrective measures are recommended, such as reentry of login code in process 384. If a resolution is found in decision 386 and corrective measures permit continuing, the next step is decision 382. Otherwise, flow is directed to oval 388 which returns operation to web page 100.

Note that decision 382 is variably reached from decision blocks 376, 380 and 386. SSL security has been earlier disclosed herein, but use of such security is very important in many ways and will therefor be discussed in detail here. Various modes of security protection are employed to provide for the following:

1. privacy of all training course material until released for publication by an authoring client.

2. assurance that all training courses developed via programs provided as part of a provider's training course development and publication services may only be used on servers made available by the provider.

3. protection against attack of training course certification testing materials generated, qualified and used as a part of training course material originally provided by the authoring client.

To provide for this wide range of protection, all files originated by an authoring client and sent to server 20 are encrypted with a public key of the authoring client, giving only the authoring client access to those files until the authoring client releases the files for publication by the service provider. Note, that even the service provider does not have access to unreleased authoring client files. Further, all files transmitted between the authoring client and service provider are encrypted in some manner. In the case of files being sent from the authoring client to the service provider, for storage on a server 20, those files are doubly encrypted. While it is well understood that double encryption does not materially add protection to a file, in this case double encryption assures that with a first encryption, using a public key of the authoring client, the provider does not have untimely access to the authoring clients files. A second encryption, using a public key of the service provider, denies use of training course material developed on the service provider's software other than on a server 20 of the service provider. Further, after release for publication and distribution, training course programs should only be made available in “run time” mode, to deny unauthorized recording and editing by those who might attack unprotected files. Similarly, files associated with certification testing are encrypted and doubly encrypted as appropriate to assure privacy and security for a student client and single source use of certification tests from a server of the service provider.

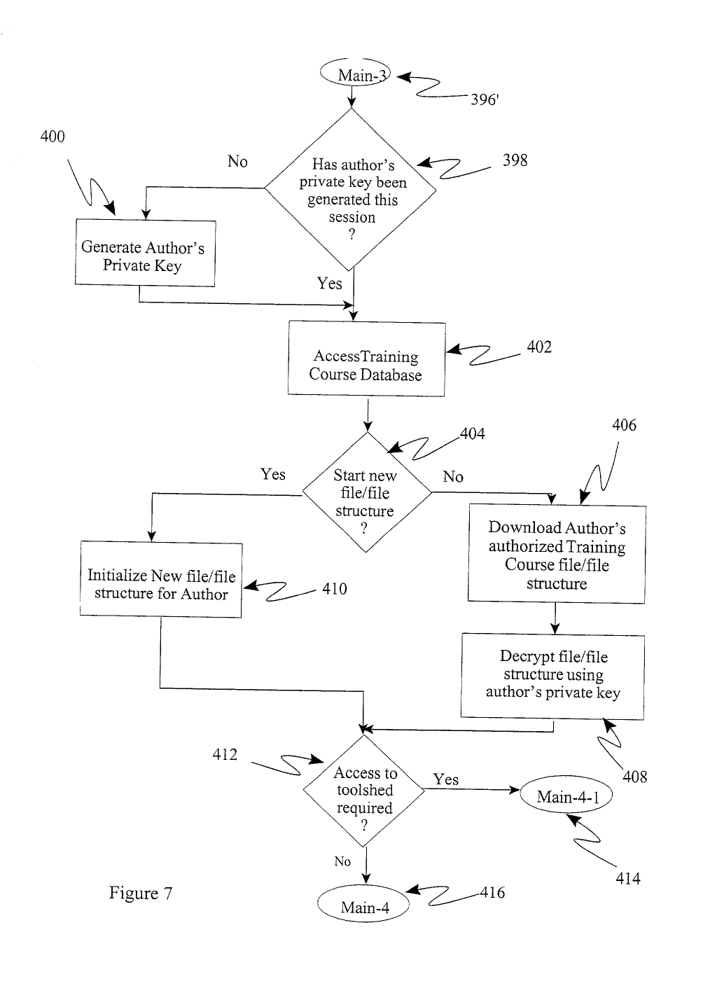

So it is that SSL security is imposed between server 20 and an authoring client work station 40 for all data transfers in process 390 if such has not already been determined to be established in decision 382. With SSL security assured, next decision 392 is a check to assure that all necessary plug-ins available from server 20 for use on work station 40 in preparation of training course material is available for browser use on work station 40. If not, plugins including a training course authoring tool, a file management tool, a key generation and a file encryption/decryption tool is downloaded from server 20 for use by the browser of work station 40 (process 394). It is preferred that these browser based tools remain resident in work station 40 to reduce Internet transmissions. Program flow continues through oval 396 to oval 396′ (see FIG. 7).

As earlier disclosed, new author generated training course material is protected by employing a public/private key combination for each author. The public key is stored in an array 290 as disclosed above (see FIG. 26). The private key of each authoring client should be resident only in memory processes of that authoring client. Once during each training course material development session an authoring client should generate a private key which is retained in browser operating space only through the session. So it is that decision 398 tests to determine whether or not a private key of the authoring client using work station 40 has been generated for the current session. If the private key does not exist in volatile memory of the browser of work station 40, a private key associated with the public key stored in array 290 of FIG. 26 is regenerated in process 400. Once the private key is available in browser operating space, process 402 provides entry for access to training course data bases.

Decision 404 determines whether or not a file already exists for a portion or segment to be worked upon during a current session. If a portion or segment has already been begun and is stored on server 20 (or in an accessible remote server 50), decision 404 leads to process 406 through which an encrypted training course file is accessed. The training course file is decrypted via process 408 using the private key of the authoring client. If no portion or segment has been begun, process 410 performs necessary initialization routines, including adding a new column to the array shown in FIG. 25 and generating a key for storage in a predetermined cell 321 of array 320.

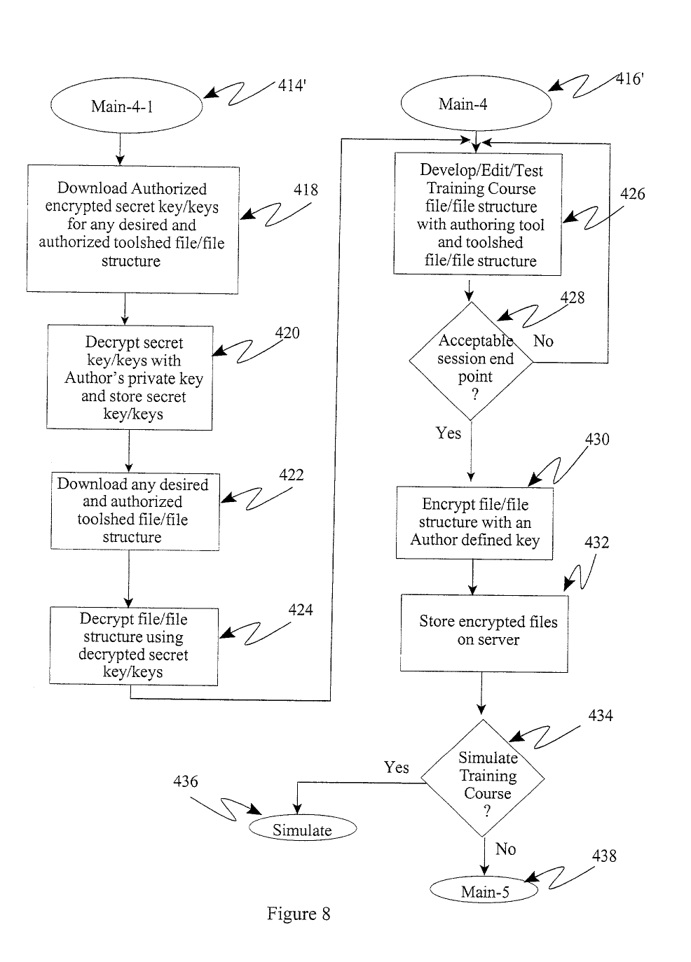

Once training course file structure has been determined, decision 412 ascertains whether or not access to tool shed 300 is desired. If access to tool shed 300 is sought, program flow is steered through oval 414 to oval 414′, see FIG. 8. Otherwise, program flow is direct from oval 416 to oval 416′, also found in FIG. 8.

Once the browser of work station 40 is configured for course development, important elements available for course development are accessible for use. As an example, an author may access development tools through tool shed 300. Process 418 provides access to selected course development tools. As an example, if the author currently using this work station 40 is Author(3), as defined in FIGS. 23-26, tools stored as tool number 2, tool number 3 and tool number 4 may be accessed through encryption keys available in tool shed 300 (see FIG. 23). Note that Author (3) is the controlling editor of tool number 2 (see FIG. 24). Tools (software files) are stored encrypted by a secret key defined by a controlling editor. As an example, for tool number 3, <key>(3) stored in A3/T3 of tool shed 300 is a secret key coded with the public key of Author (3).

If Author (3) elects to use tool number 3, <key>(3) is acquired from tool shed 300 and decrypted using the private key of Author (3) via process 420. Note the private key of Author (3) is stored in volatile memory of the browser of work station 40 as a result of process 400 (FIG. 7). Through file links available from tool shed 300, each selected tool is downloaded (process 422) and decrypted for use (process 424).

With development tools in place, the author (in this example Author (3)) is ready to initiate a session to develop, edit and test a portion of a training course in progress (process 426). If the training course in progress has previously been started, such as portion 3 for Author (3) shown in FIG. 25, Author (3) acquires necessary file access links from segment control array 320. In such a case, portion 3 is downloaded from server 20 to be edited. As a part of process 426 both portions or segments of training courses and new or edited training tools may be developed.

Upon completion of the session, local testing of session results permits decision 428 to determine whether or not additional development and editing is required before proceeding to end the session. If more development and editing is required, process 426 is reactivated. If an acceptable endpoint has been reached, flow continues to process 430.

Process 430 encrypts files to be stored with a public encryption key defined by the Author, in the example, Author (3). If the file to be encrypted is a portion or segment of a training course, it is anticipated that a public key of a public/private key combination will be used for encryption. If the file to be encrypted is a tool (an addressable tool from tool shed 300), a secret key is created by the author for that tool.

Process 432, following process 430, instructs server 20 to receive and store the encrypted files. Note that links and encrypted keys to newly stored files are then added to a cell of an appropriate array. As an example, if the encrypted file to be stored is a segment or portion of a training course, a cell of array 320 is modified, e.g. cell A3/S3. If a new or modified tool is to be stored, a new T (Tᵢ) where access data for this tool is found in the ith column of FIG. 23 and the appropriate (ith) compartment is filled. In addition, the tool originating author has the prerogative of selectively authorizing other authors use of the new Tᵢ tool. For each authorized author, the originating author stores the secret key of tool Tᵢ encrypted with the public key of the author to be authorized in an intersecting compartment of the author to be authorized and tool Tᵢ. As an example, if the originating author is Author (3), tool Tᵢ is tool T3 and the author to be authorized to use tool T3 is Author (2), in compartment A2/T3 of tool shed 300 (FIG. 23) the secret key of tool T3 encrypted with the public key of Author (2) is stored. Of course, other title information and file links associated with tool T3 are also stored in compartment A2/T3 to permit facile access by Author (2). Note that access to tools through tool shed 300 is to “run time” versions of each tool and not to a file which may be edited. The originating author maintains control to the editable version of the file through keys stored in tool control file 310 (FIG. 24).

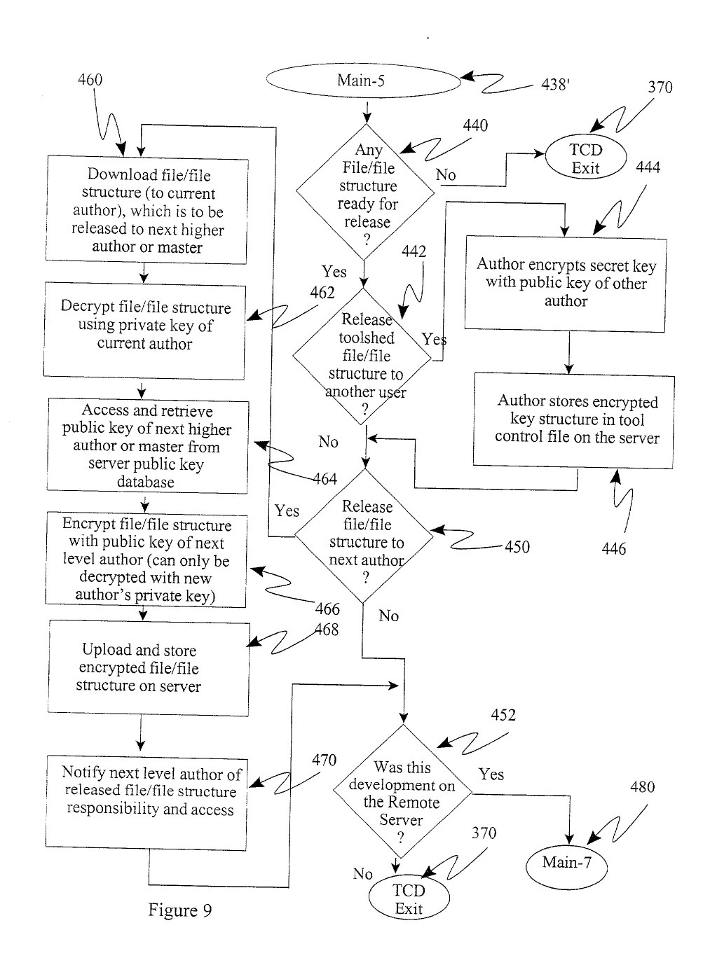

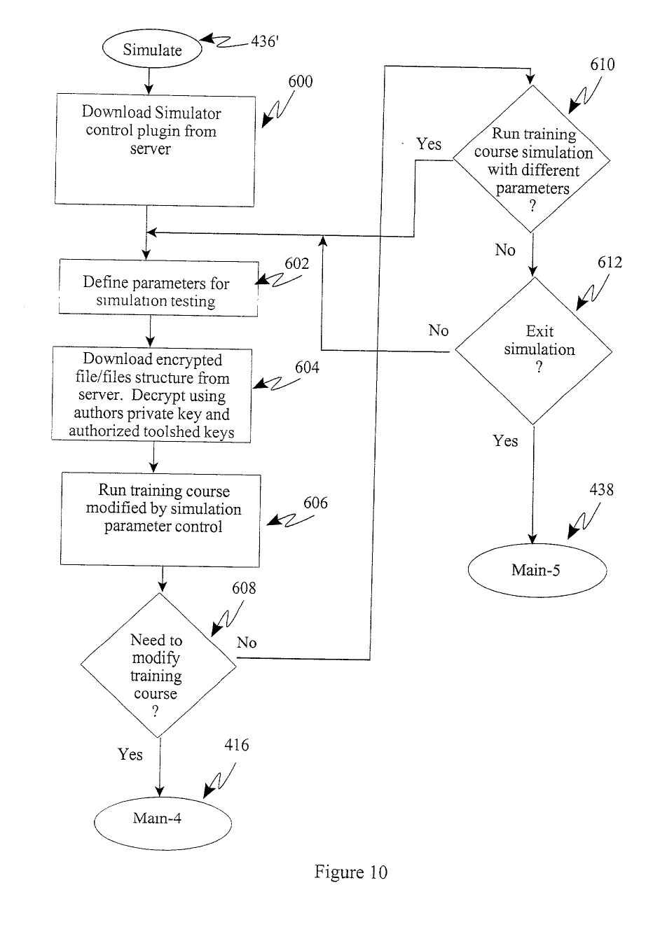

If the newly developed tool, segment or portion of a course or an entire course is ready for simulation testing to validate Internet preparedness, decision 434 which follows process 432 directs program flow to oval 436 to oval 436′ of FIG. 10. Otherwise, flow continues through oval 438 to oval 438′, shown in FIG. 9.

Decision 440 determines whether any file developed via process 426 is ready for release. If no file is ready for release, flow proceeds to oval 370 which is a training course development exit. Otherwise, flow continues to decision 442 which selectively provides a flow pathway for release of control of a particular tool to another author. If a tool is to be released to another author, usually to a next higher person on a management ladder, controlling encrypting keys are transferred to the other author. To accomplish this, the secret encrypted key stored in a cell 312 of tool control file 310 in a column associated with the tool to be released is transferred to the browser of work station 40. Process 444 brings the contents of cell 312 associated with the tool into work station 40 from server 20 where those contents are decrypted and reencrypted with a public key of the other author. As an example, note in array 310 of FIG. 24 that cell A1/T4 currently shows control of tool T4 by Author (1). However, tool T4 may have been originally created by Author (3) and, by process 444 and 446, transferred control of tool T4 to Author (1). Also note that by encrypting the secret key of tool T4 with the private key of Author (1), only Author (1) can change or modify the file associated with tool T4.

As a tool may be released to another author, so may a segment or portion of a training course being developed by one author be released to another author. In fact, when many authors are involved and when a single work product, the training course, itself, is complete, it must be accumulated into a single or at least a linked file. For this reason, it is also necessary to provide for release of segments or portions of files from one creating or controlling author to another author. Decision 450 determines whether or not such a release shall occur. If there is to be no such release, decision 450 steers program flow to decision 452.

If a release is to occur, the file to be released is accessed to be reformulated in work station 40 (process 460). The file is decrypted, using the private key of the transferring author (process 462). The public key of the author to whom the file to be released is accessed from array 290, shown FIG. 26 (process 464). The file to be released is encrypted using the public key of the other author (process 466). The newly encrypted file is uploaded and stored on server 20 (process 468) with an appropriate cell 321 of array 320 (FIG. 25) being updated with necessary key, link and title indicia to permit the receiving author to address and acquire the released file. Finally, the receiving author is notified of the transfer (process 470).

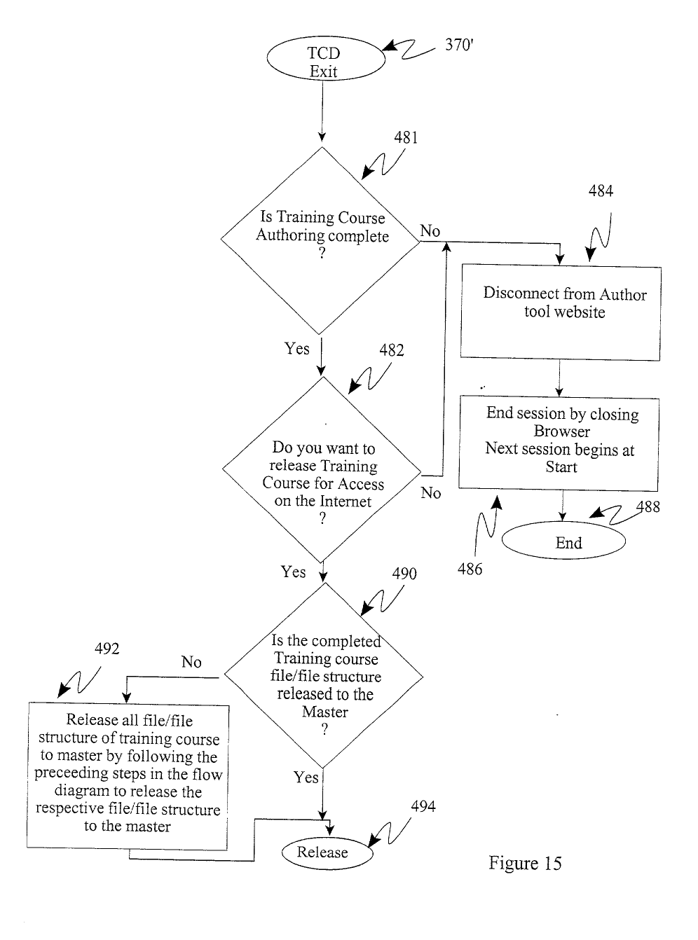

Upon exit from process 470 program flow joins program flow from decision 450 at decision 452. If the preceding development procedure was performed with a remote server 50 communicating through a direct communicating link 60 to work station 40, program flow is steered through oval 480 to 480′ to a portion of a flowchart previously disclosed in detail above. Otherwise, program flow is steered to TCD exit oval 370 and therefrom to oval 370′ of FIG. 15.

As a first exit step, it is determined whether or not the training course being developed is complete and ready for publication on the Internet (decision 481). If so, the program is steered to decision 482, if not the program is steered to process 484. Decision 482 determines whether or not the current training course is to be released for publication by the service provider. If not, the next step is also process 484.

At process 484, work station 40 connection over Internet link 30 to server 20 is broken, ending all program development activity. By the following process 486, the browser of work station 40 is purged of all links to course development plugins including access to the training course authoring tool(s), file management tool, key generation tool and any associated encryption/decryption tool. In addition, all temporarily stored information, such as the private key of the using author and other secret key information held in volatile memory, is expunged from work station 40 memory. Work station 40 may then be returned to web page 100 through oval 488.

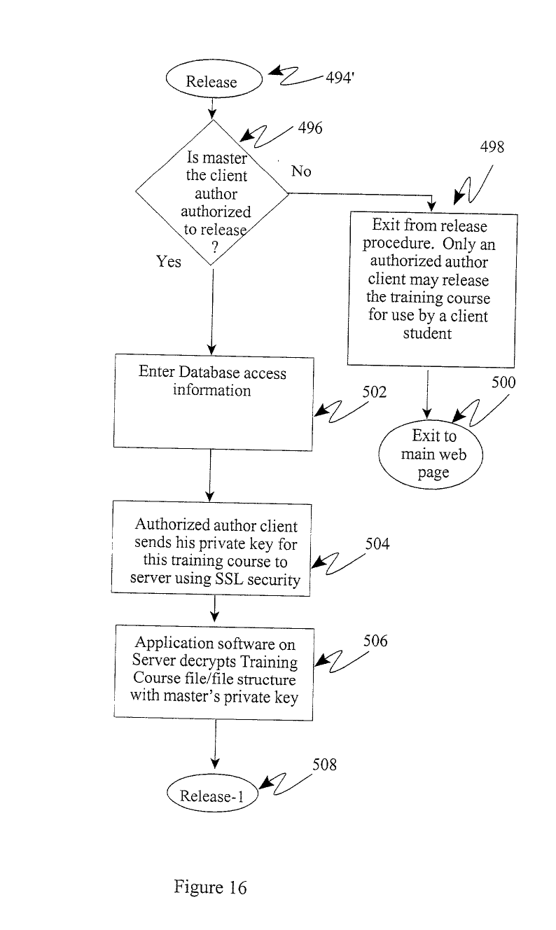

If the current training course is to be released for publication and broad or selective dissemination to student clients, next decision 490 determines that all files associated with the training course are released to a single master. If files are not yet encrypted for the single master, process 492 accomplishes such a release. Paths from both decision 490 and process 492 traverse to oval 494 and to oval 494′ of FIG. 16.

As a designated master may not be the author client authorized by the service provider to release a given training course from publication and dissemination, identification is required for such a release as indicated by decision 496. If the master does not qualify as an authorized author client, such an indication is given to the master and program flow is steered to process 498 which exits through oval 500 to web page 100.

If the master is an authorized author client, a predetermined schedule for a database which delineates any restrictions upon publication, student clients and others who may desire access to the newly released training course is filled out. Other information related to student client billing (such as a time schedule for unrestricted use during an introductory period) and limits of billing to the authoring client for early inservice training is also recorded and made part of the database. These and other databases as recorded and defined for each individual client are accomplished via process 502.

Once conditions of release are completed by process 502, release is accomplished by sending the private key associated with the newly released training course to server 20 using SSL security (process 504). Process 506 decrypts the newly released training course file/file structure using the private key and assembles the newly released training course into a “run time” program. Note, this is the first time the service provider can provide a run time version of the newly released training course.

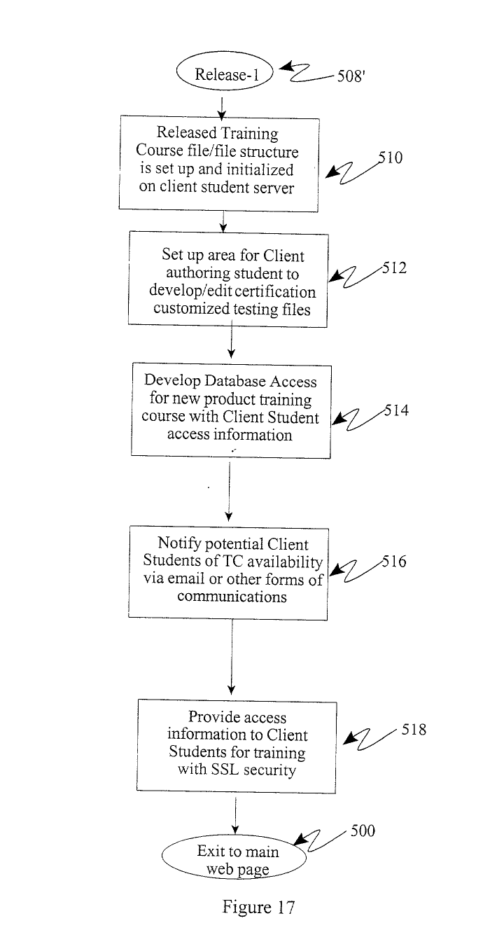

From process 506 program flow is through ovals 508 and 508′ (found in FIG. 17). As indicated in process 510, the newly released training course may be set up and initialized on a separate student client server (generally also numbered 20). Memory within the student client server 20 is dedicated for student client testing files (process 512). A database is established for each student client test results (process 514). Prospective student clients are notified of availability of the newly released training course (process 516). Finally, access information is provided to prospective students (process 518).

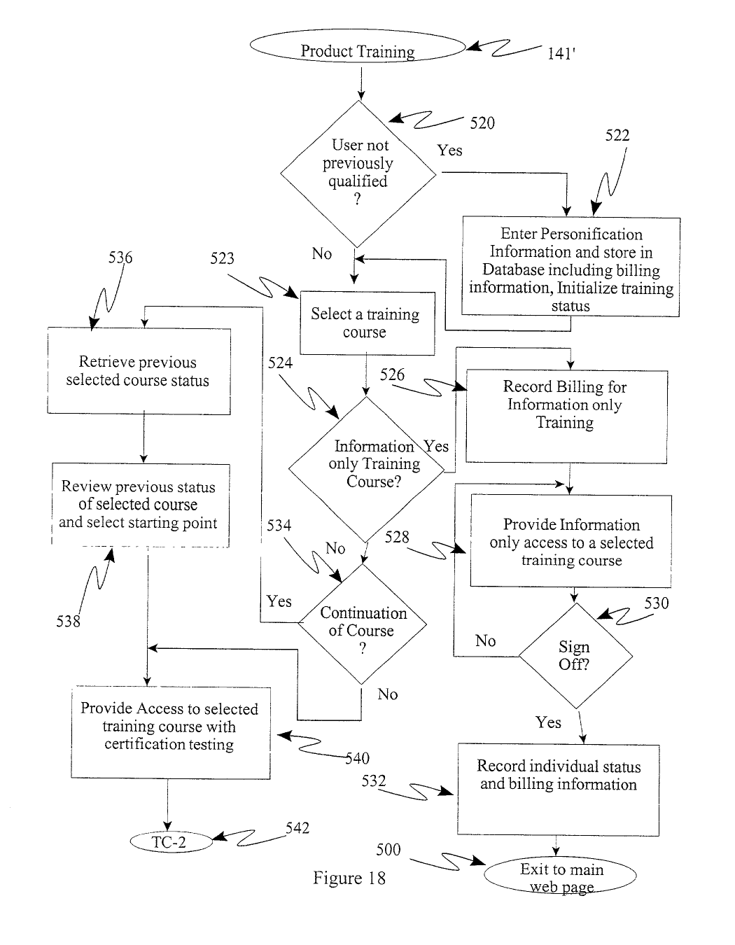

Reference is now made to FIG. 4, wherein a hypertext link 140 to Product Training is shown. In this case, home page 100 has likely been accessed through a student client work station 80. Although other work stations, such as work stations 40 and 70 may be used, any work station used in a student training environment is considered to be a work station 80. Selecting link 140 steers program flow to process 140′ and then through selection to oval 140 and to linking oval 140′ shown in FIG. 18. Entry to Product Training begins with establishing whether or not a prospective student has been previously qualified as a user (decision 520). If the prospective student has not been previously qualified, program flow continues to process 2522. Process 522 qualifies the prospective student using billing qualification processes which are well known in Internet billing. If the user is not qualified to be a student, program flow exits to web page 100. Once qualified, a prospective student returns to main program flow at decision 523. Process 523 provides a menu or other avenue by which a particular training course is selected. Such selections may be made by training category (e.g. type of instrument or training area), by product manufacturer, by student client (facility) preferred training group or by other factors defined by authoring clients (product producers) and student clients (product users). Upon training course selection, a course initiating flag is set to indicate a course starting point at the beginning page of the course.

From decision 520 continuing execution of training may follow one of the three paths:

1. taking a course for information only (decision 524).

2. continuation of a previously entered course (decision 526).

3. take a course with intent to complete certification testing (process 528).

If a course is to be taken for information only, decision 524 steers to process 526 where billing data is presented, accepted and recorded for future use. In following process 528 a particular training course is selected from a training course menu extracted from available training courses, either by company or by category. At that point a “run time” program of the selected training course is provided to the requesting student client work station 80.

Upon completion of the selected training course, a decision 530 permits the same course to be rerun or a new course to be reviewed before exiting by a selectable return path to process 528. If the student elects to end this training session, decision 530 leads to process 532 where a record is made for billing and other training status information purposes. From process 532 an exit is made via oval 500 to web page 100.

If a training course was begun at a prior time, and exited prematurely, continuation may be accomplished via decision 534. If a course is to be continued, process 536 is entered from decision 534. At process 536, status is recalled from data previously stored for a selected training course file to determine all salient factors, including billing information. From previous status, course initiating flag is reset in process 538 to provide a reentry link which determines course reentry point.

Process 540 selects and displays entry page (a first page of the training course if the course initiating flag has not been reset, otherwise a page determined by the reentry link), and the training course proceeds as defined and released by the authoring client. It should be noted that the course is provided in a “run time” format so that recording of a course, as run, will not permit pirating and unauthorized use of the selected course and will therefore not require a proxy. The selected training course proceeds to completion in process 540.

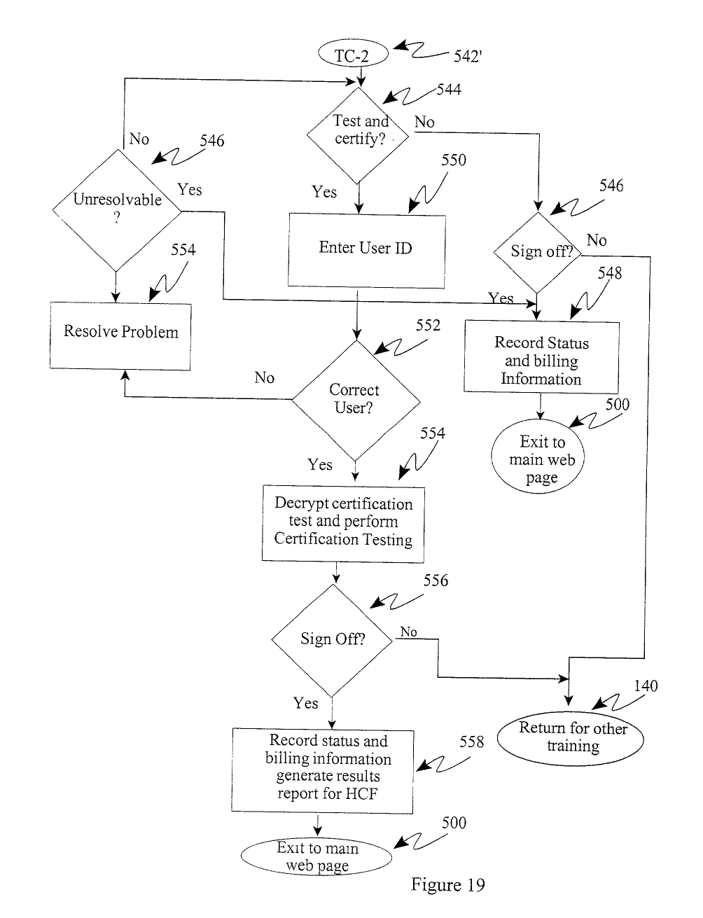

At the completion of the selected training course, program flow continues through linking oval 542 and linking oval 542′ (FIG. 19) to decision 544. Decision 544 determines whether or not a student client user elects to be certified on the selected training course. If the student client user does not elect to be certified, decision 544 steers program flow to decision 546. Decision 546 determines whether or not the student client user elects to take another course or to sign off. If the student client user elects to take another course, the program proceeds through linking oval 140 to oval 140′ (see FIG. 18). If the student client user elects to sign off, program flow continues to process 548 where billing records are adjusted and other historical data, such as student client user and student client facility records, are recorded. From process 548 program flow exits to web page 100 via exit link oval 500.

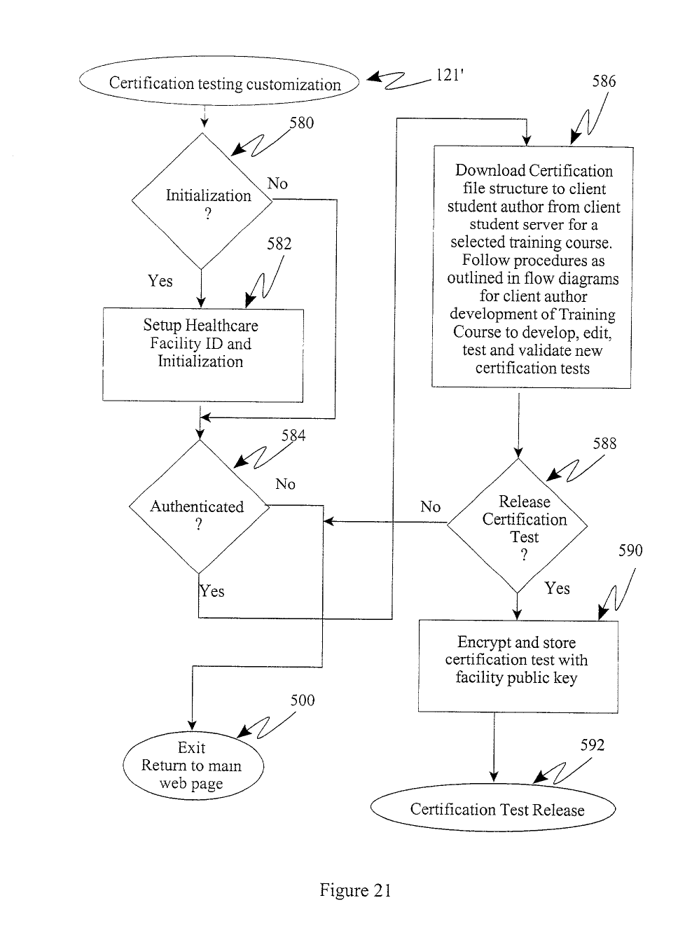

If the student client user elects to be tested and certified on the selected training course, decision 544 steers program flow to process 550. As facility certification generally requires substantiated records of training, each student client user being tested must be authorized and authenticated. Process 550 derives a student client facility authorization code or previously recorded biometric identification which authenticates the student client user. The derived information is tested against previously recorded certification files (see FIG. 21) at next decision 552. If criteria established in the previously recorded certification files is not met, the student client user may address a supervising authority at the student client facility to attempt to resolve the problem (process 554). If the problem is resolved program flow reenters decision 544 as a result of decision 546. If the problem is not resolved, program flow proceeds from decision 546 to process 548, earlier disclosed.

It should be noted that a generic test may be provided by an authoring client (product provider) which provides a student client with feedback concerning quality of training and understanding received by taking the selected course. However, such testing is not properly controlled and will likely not be universally accepted for certification. Such a generic test is considered to a part of process 540 and is not further detailed herein.

Decision 552 permits an authenticated and authorized student client user access via process 554 to certification testing of material provided by the selected training course. Process 554 downloads the student client facility generated and controlled certification test to the work station 80 being used by the student client user. Therein the downloaded certification test is decrypted (see FIG. 21 for encryption/decryption information) and provided as a sequence of queries determined by the student client facility (also see FIG. 21). At the end of certification testing, results are recorded and a log is made of time, place and user data, then program flow continues to decision 556.

At decision 556, the student client user may elect to return through link oval 140 to link oval 140′ (see FIG. 18) for additional training or exit the current training cycle by signing off product training. If the student client user elects to sign off, process 558 consequently records billing and other associated database information.

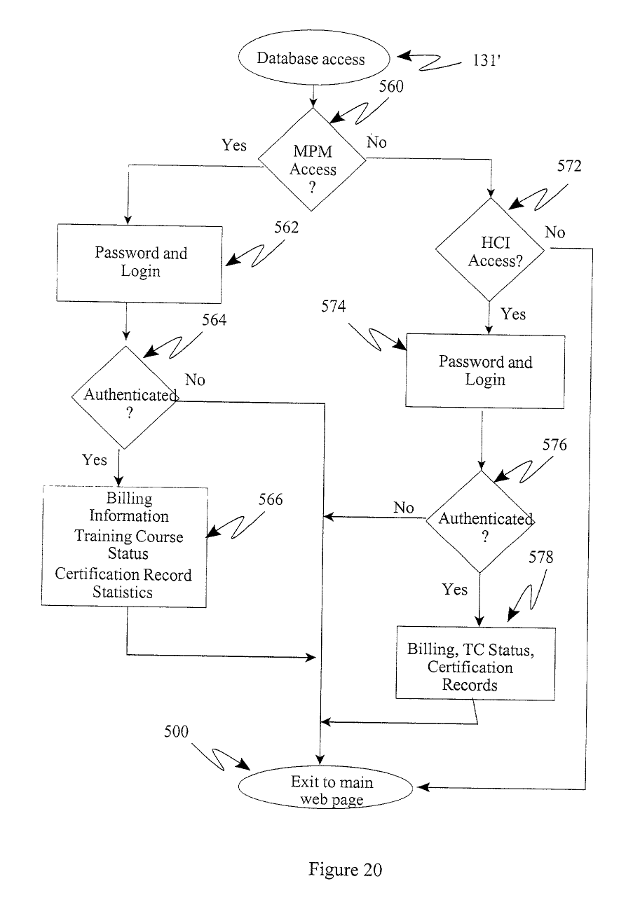

Among the more important aspects of systems using the inventive methods disclosed herein are collecting and making available a broad cross section of information from a dynamic data base and standardized training and testing processes across an expanse of training on related competitive products. In both of these cases privacy is a paramount issue. Database information must be considered proprietary for the same reasons that training and testing information are considered proprietary. Database access is achieved through hypertext link 130 to process 130′ (see FIG. 5) which, when selected, leads to linking oval 131 and then to linking oval 131 ′ (see FIG. 20). Note, a change in nomenclature is used to designate facility management, rather than user and service functions. Generally authoring clients work for medical product manufacturers (MPM). Student client users and supervisors work for health care facilities (HCF). Of course, the same kind of inservice training can apply to other industries, such as the automotive or aircraft industries. In such cases, those who are students and supervisors of students would be drawn from the other industries, but for this example those who are trained shall be considered as employees of HCF.

First entry after oval 130′ is a determination of whether an MPM or other access is desired (decision 560). If MPM access is indicated, program flow proceeds to process 562. A password, login code or other biometric data, which fills a predetermined requirement, is requested and acquired via process 562. Note that such passwords, login codes and biometric data are unique with each MGM and, therefore, only permit each MGM access to database information associated with training courses of that MGM.

Following decision 564 tests authenticity of the requested information. If the requested information does not authenticate the requester, program flow exits through linking oval 500 to web page 100. If requestor is authenticated, a review of billing information, training course status, and certification record statistics may be reviewed in process 566. It should be noted that action items listed in process 566 are only exemplary and other processes may be provided for database review by each MGM. It should also be noted that each MGM may only review that database information which is directly associated with course training material generated by authoring clients of that organization.

If, decision 560, access is other than MGM, decision 572 determines whether or not HCF access is desired. If no HCF access is elected, program flow returns to web page 100 through exit oval 500. Otherwise, a password, login code or other biometric data, which fills a predetermined requirement, is requested and acquired via process 574. Note that such passwords, login codes and biometric data are unique with each HCF and, therefore, only permit each HCF access to database information associated with training courses of that HCF.

Decision 576 tests authenticity of the requested information. If the requested information does not authenticate the requester, program flow exits through linking oval 500 to web page 100. If requester is authenticated, the requesting HCF may review billing information, training course status, and certification records as part of process 578. In particular, certification records may be encrypted by a public code of the HCF for decryption in process 578 to protect the privacy of both the HCF and student client user. It should be noted that action items listed in process 578 are only exemplary and other processes may be provided for database review by each HCF. It should also be noted that each HCF may only review that database information which is directly associated with course training material generated by authoring clients of that organization. No other organization, even the provider of server 20, has access to certification records. Upon completion of process 578, program flow returns to home page 100 through exit oval 500.

Each HCF may provide a customized test to help both a student client user and the HCF to meet certification requirements. For such purposes, standardized tests, such as those provided by a MPM (training course author client), may be not meet particular HCF certification requirements. For this reason, a certification test authoring and review hypertext link 120 enters a certification testing customization process 120′ which proceeds through linking oval 121 (FIG. 5) to entry oval 121′ (see FIG. 21).

Next decision 580 determines whether or not a requesting HCF has been previously authorized to generate a customized test. If no previous authorization has been accomplished, process 582, entered via a first path from decision 580, provides an interface with the provider of server 20 to setup necessary identification protocol and ID entry modes. Also, other database information, such as billing records, certification records and statistics and training course utilization are initialized.

Once process 582 is complete, program flow is to decision 584. Program flow is also to decision 584 via a second path from decision 580 where authorization has been previously received. Decision 584 tests authenticity of identification of a prospective student client author. If the prospective student client author is properly authenticated, program flow continues to process 586. Otherwise, program flow exits to main web page 100 through exit oval 500.

It is anticipated that, upon release of a training course, an MGM will often release an associated testing and review file. While this testing and review file may be used directly by both a student client user and an HCF for certification testing, it is more likely that each HCF will need to modify such a testing and review file to formulate a certification test which more closely meets certification requirements of that HCF. For this purpose, next process 586 provides access to the associated testing and review file and linking information necessary customizing this testing and review file, see processes 512 and 514 of FIG. 17. If no such associated testing and review file has been generated by an MGM, a student client author may generate a certification test from scratch. For all such purposes, all necessary file structures for student client authoring is provided as part of process 586. In addition process 586 comprises certification test development process which are substantially the same as those available for training course development via hypertext link 110 (see FIG. 5).

Upon completion of a certification test associated with a selected training course, a decision to release the certification test file at decision 588 results in process 590 encrypting the certification test file in a “run time” mode assembly. Such encryption utilizes the public key of the HCF producing the certification test to assure each time the certification is used it will not be corrupted.

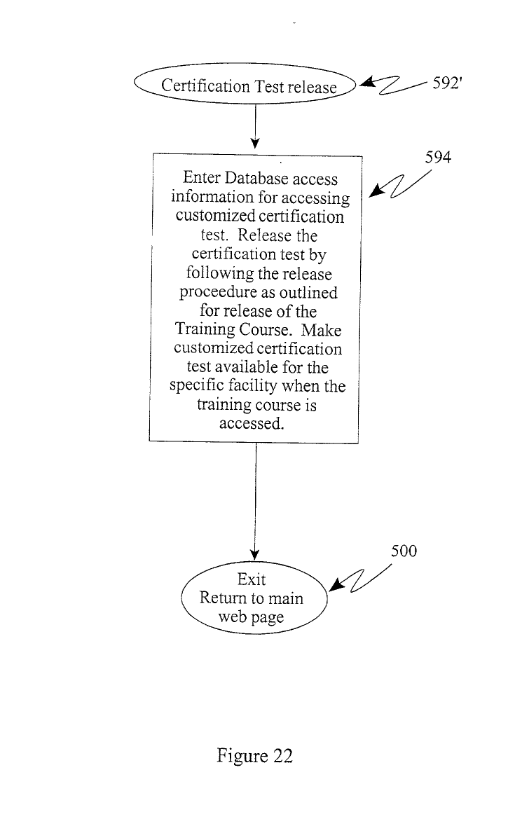

From process 590, program flow passes through oval 592 to linking oval 592′ and then to process 594 (see FIG. 22). Process 594 sets up files, links and pointers associated with use of this certification test. Essentially the same release procedures used for training course development (via hypertext 110) are used for release of this certification test. Links are also provided to the associated training course such that when a student client user from this HCF accesses the associated training course, this certification test is resultantly accessed as well via product training hypertext link 140 (see FIG. 4). Upon completion of process 594, program flows through oval 500 to web page 100.

Referring once more to FIG. 21, should the certification test being prepared in process 586 not be ready for release, program flow is to exit oval 500. Program flow from exit oval 500 is to web page 100.

As shown in FIGS. 4 and 5, a general product review program, permitting advertising by MPM's is accessible through hypertext link 150. Hypertext link 150 leads to process 150′ (FIG. 5) and is connected to a product presentation program through link 151. As such advertising programs are well known in the Internet art, program flow emanating from oval 151 will not be further addressed herein. Further, exiting browser, as indicated by process 598 (FIG. 5) is by processes which are standard for browser closure and will not be further addressed herein, as well.

Should a decision to simulate a course be made at decision 434 (see FIG. 8), an exit is made via oval 436 to oval 436′ of FIG. 10. Following simulation entry through oval 436′, process 600 downloads a simulator plugin from server 20 to work station 40 to make work station 40 a facilitator. As part of the simulator plugin, process 602 provides an ICPO opportunity to define parameters which are used in the simulation. Such parameters may include setting a predetermined data transmission rate from server 20. Once the simulation parameters are established, process 604 downloads encrypted files of the course to be simulated server 20. These encrypted files are decrypted at work station 40 using the private key of the author or person authorized to test the course, also as a part of process 604. In process 606, the so-transmitted training course is then run under control of the simulation parameters. Decision 608 permits either modification of the training course, rerunning the course or running the course with new parameters. If there is a need to modify the training course, decision 608 steers program flow to oval 416 for reediting (see FIG. 8). Otherwise, next decision 610 determines whether or not the current course is to be run again with new parameters. If so, decision 610 steers operation to process 602. If not, next decision 612 determines whether or not the training course is to be rerun without a parameter change or whether the simulation ends. If so, decision 612 directs program flow to process 602 without parametric change. If not, the simulation is ended via oval 438 to oval 438′ as shown in FIG. 9.

Reference is now made to FIG. 1 wherein a remote server 50 is shown to be disposed between a work station 40′ and a server 20. In similar fashion a remote server 50′ is shown to be disposed between work station 70′ and server 20. Remote servers 50 and 50′ are likely made of identical parts.

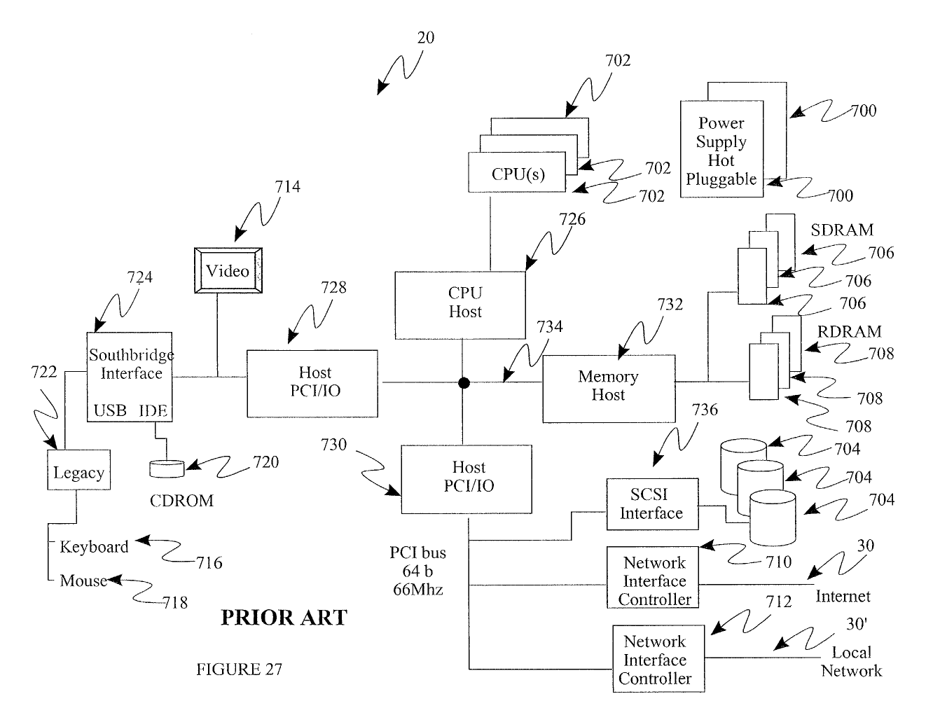

A block diagram of an exemplary server (i.e. server 20) is shown in FIG. 27. Such servers are well known in the Internet art and generally comprise a plurality of centrally and peripherally disposed modules. Server 20 is designed with sufficient redundancy and versatility to operate when parts fail and to allow new parts to be introduced during operation. In this manner, server 20 is kept on-line seven days per week, twenty-fours hours per day. For this reason, hot-pluggable power supplies (each numbered 700) are used. Also, a plurality of CPU's (each numbered 702) and a plurality of hot pluggable disk drives (each numbered 704) are employed. The disk drives are provided with disk mirroring and disk cloning software to assure backup when necessary. Similarly, a plurality of SDRAM's (generally numbered 706) and RDRAM's (generally numbered 708) provide dynamic memory for server 20. A network interface controller 710 provides an interface to Internet link 30. Similarly, a network interface controller 712 provides an interface for a local network line 30′.

Server 20 also comprises devices through which some mechanical communication is made. These devices include a visual display 714, a keyboard 716, a mouse 718 and a CDROM 720.

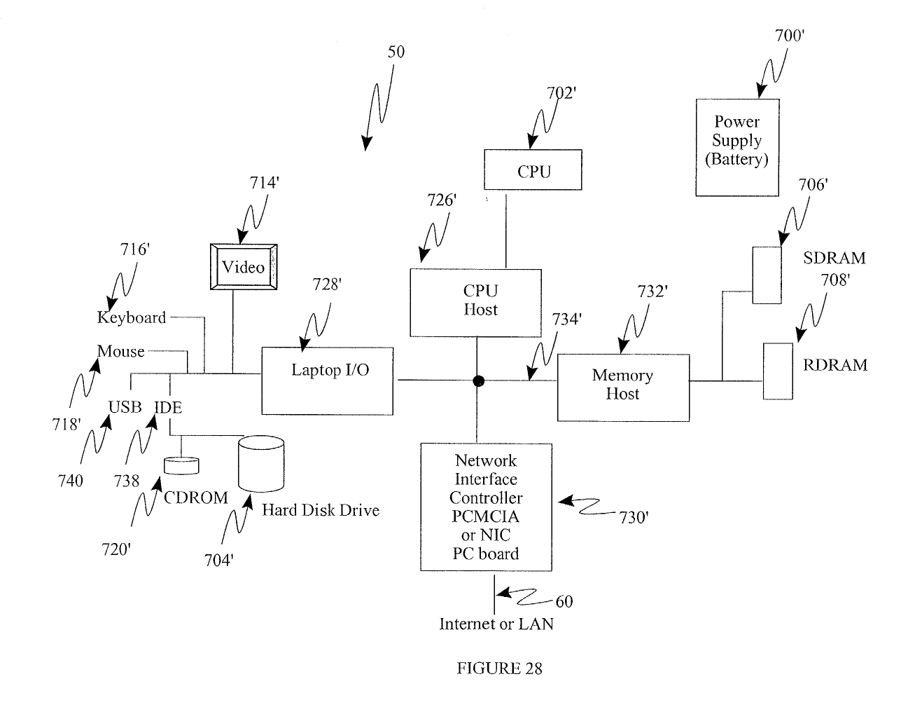

Various interfaces are employed through which the devices and other of the parts named above are synchronized and communicate. These interfaces include a peripherally disposed Legacy interface 722 for mouse 718 and keyboard 716 and a more centrally disposed interface 724 which interfaces to Legacy interface 722 and CDROM 720. Four host interfaces, a CPU host 726, a first PCI/IO host 728, a second PCI/IO host 730 and a memory host 732, are connected by a common bus 734 and provide for synchronized communication among the parts as shown in FIG. 27. CPU host 726 is therefore connected to each CPU 702. Memory host 732 is connected to each SDRAM 706 and each RDRAM 708. Host PCI/IO 730 is connected to a SCSI interface 736 and there through to each disk 704. Host PCI/IO 728 is connected to video display 714 and interfaces 724. Server 20 as shown in FIG. 27 should be viewed as exemplary only and is presented herein for comparison to remote server 50 shown in FIG. 28. All parts of server 20 are commercially available and servers which are similar in form and function to server 20 have wide Internet contemporary use.

Remote server 50 (and remote server 50′ which may be identical to remote server 50) is much simpler than server 20 and may be in the form of a lap top personal computer or a special purpose black box. Where the various parts, devices and modular components of remote server 50 are similar in form and function to parts, devices and modular components of server 20, primes of those numbers used for server 20 are used for remote server 50.

In remote server 50, power supply 700′ is preferably a rechargeable battery. Approximately 128 megabytes of SDRAM 706′ and RDRAM 708′ should be provided. CPU 702′ is preferably equal to or better in word size and speed to a Pentium Processor commercially available from Intel Corporation.

Remote server 50, like server 20, comprises four centrally disposed interfacing components, CPU host 726′, memory host 732′, a network interface controller 730′ and a laptop I/O 728′ . The four centrally disposed interfacing components commonly communicate over a bus 734′ and may be disposed on a mother board which houses CPU 702′.

Network interface controller 730′ is either a PCMCIA or NIC PC board and provides a communicating link between bus 734′ and an Internet or LAN port for connecting via communicating link 60 to work station 40′ (or work station 70′), see FIG. 1. Laptop I/O 728′ communicates with video display 714′, keyboard 716′, mouse 718′, and CDROM 720′ and hard disk drive 704′ through an IDE interface 738. The capacity of hard disk drive 704′ is preferably six gigabytes or greater. Laptop I/O 728′ also provides a communicating link to USB 740. It is important to note that video display 714′, keyboard 716′ and mouse 718′ are optional, in that a keyboard, video display and mouse of an associated work station 40′ (or 70′) may be used with communications provided through network interface controller 730′.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A method for developing, releasing and distributing training courses via the Internet, the method providing a client, who authors the training courses, release control and secure confidentiality of all contents of the training courses prior to authorized course release by the client and which provides selective control whereby the training courses can only be made available over the Internet by a predetermined training course service provider, the method comprising the steps of:
a) providing at least one computer having a browser and an Internet communicating link for use by the authoring client;
b) providing a server which comprises an Internet communicating link for the purpose of communicating with the at least one computer for receiving training course development material and assembling the training material into training courses and which further comprises applets, plug-ins and other software programs for reconfiguring the browser as a training course authoring tool;
c) establishing an application service provider connection between the at least one computer and the server;
d) communicating, as downloading software available from the server, applets, plug-ins and other program software by which the browser is reconfigured to provide a training course authoring tool within the at least one computer for use by the authoring client;
e) as a part of the authoring tool, providing an encrypting key defining program and an encrypting program which encodes all training course material composed by the authoring client to provide a securely encrypted file of all such course material sent to the server to be stored therein;
f) accessing the server via the at least one computer for the purpose of reconfiguring the browser as a training course authoring tool and receiving the encrypting key program;
g) defining a secure encrypting/decrypting key set for selected use with the at least one computer;
h) using the authoring tool to compose training course development material which is at least a portion of a predetermined training course as an Internet transmittable file;
i) encrypting the file;
j) transmitting the file to the server for assembly and storage as an organized, encrypted training course file which can only be used after decryption thus assuring that any such file can only be accessed from the server for use solely by the authoring client.

2. The method according to claim 1 further comprising the step of assembling within the server the encrypted transmitted training course file with any other encrypted so transmitted training course files of the predetermined training course to provide an authoring client retrievable file which can only be used in any manner after decryption using the encrypting/decrypting key set, disposed within the at least one computer, thus assuring that the assembled file can only be used as training course material via the server by only the authoring client.

3. The method according to claim 1 further comprising a step of using SSL public/private key encrypted transmission for communications between the authoring client and server.

4. The method according to claim 1 comprising an additional step of defining a server based public key file whereby public keys of multiple authors are made available to other authors who are authorized access to training course development files.

5. The method according to claim 1 comprising an additional step of defining a server based tool shed whereby common tools used in a training course is made to multiple authors.

6. The method according to claim 5 comprising an additional step of defining a server base tool control file.

7. The method according to claim 1 comprising an additional step of defining a segment control file whereby multiple authors may cooperate in production of a single training course.

8. The method according to claim 2 comprising the steps of requesting the assembled training course from the server, then receiving and decrypting the training course within a computer having the secure encrypting/decrypting key set, for testing and editing purposes.

9. The method according to claim 8 wherein the requesting step comprises defining parameters associated with a desired data transmission rate and characteristics to simulate expected predetermined variations in Internet transmission and reception.

10. The method according to claim 9 comprising a further step of simulating the desired data and transmission and characteristics by the server while sending the assembled training course to the computer through which the requesting step is made.

11. The method according to claim 1 comprising a step of doubly decrypting received data to decode files encrypted by both the encrypting key defining program and as an SSL public/private encrypted transmission.

12. The method according to claim 1 comprising a step of transmitting the secure encrypting/decrypting key set to the server, thereby permitting decryption at the server site of the training course file as currently assembled thereat for publishing and distributing a released Internet training course by the server.

13. The method according to claim 1 comprising a step of adding certification testing material to the predetermined training course by the authoring client.

14. The method according to claim 13 further comprising a step of providing, from the server, applets, plug-ins and other programs to at least one computer at a student client site to provide an authoring tool thereat.

15. The method according to claim 14 comprising steps of editing and adapting the certification testing material to meet particular certification requirements at the student client site.

16. The method according to claim 15 comprising step of providing, as a part of the authoring tool, an encrypting key defining program and an encrypting program which encodes all certification testing material composed by an author at the student client site to provide a securely encrypted file of all such certification testing material sent to the server.

17. The method according to claim 16 comprising step of defining a secure student client encrypting/decrypting key set for selected use with the at least one computer at the student client site.

18. The method according to claim 17 comprising step of encrypting the certification testing material using the student client encrypting/decrypting key set.

19. The method according to claim 18 comprising step of composing and transmitting the file to the server for assembly and storage as an organized, encrypted certification course testing file which can only be used after decryption using the secure encrypting/decrypting key set thus assuring that any such file can only be accessed from the server for use solely by the authoring student client.

20. The method according to claim 19 further comprising the step of assembling within the server the encrypted transmitted certification testing course file with any other so encrypted certification testing course files of the predetermined training course to provide an student client retrievable file which can only be used in any manner after decryption using the secure encrypting/decrypting key set, disposed within the at least one computer, thus assuring that the assembled file can only be used as training course material via the server by only the student client.

21. The method according to claim 19 further comprising a step of using SSL public/private key encrypted transmission for communications between the authoring client and server.

22. The method according to claim 21 comprising a step of doubly decrypting received data to decode files encrypted by both the encrypting key defining program and as an SSL public/private encrypted transmission.

23. The method according to claim 21 comprising a step of transmitting the student client secure encrypting/decrypting key set to the server, thereby permitting decryption at the server site of the certification testing course file as currently assembled thereat for selectively publishing and distributing a released certifying Internet testing course by the server.

24. The method according to claim 1 comprising a further step of accessing and decrypting a training course file for the purpose of editing the training course material at the at least one computer.

25. The method according to claim 24 comprising repeating steps (c) through (j).

26. The method according to claim 1 comprising a further step of establishing an application service provider connection between the at least one computer and a portable remote server over a direct line, said remote server comprising applets, plug-ins and other software programs for reconfiguring the browser as a training course authoring tool.

27. The method according to claim 26 comprising a further step of transmitting applets, plug-ins and other software programs from the remote server to the at least one computer for reconfiguring the browser as a training course authoring tool.

28. The method according to claim 26 comprising steps of down loading an encrypted training course development material file from the server via the Internet to the portable remote server and files for reconfiguring the browser as a training course authoring tool the authoring client using the portable remote server.

29. The method according to claim 28 comprising performing steps (e) through (j) wherein the remote portable server is the server for the at least one computer.

30. The method according to claim 29 comprising a step of transmitting an encrypted training course file over the Internet from the remote portable server to a centrally disposed server to be stored as an encrypted file in the centrally disposed server.

31. The method according to claim 27 comprising a step of transmitting a new encrypted file to the remote server for assembly and storage through the browser which can only be used after decryption using the secure encrypting/decrypting key set, thus assuring that any such file can only be accessed from the remote server for use solely by the authoring client.

32. The method according to claim 30 further comprising the step of assembling within the remote server the encrypted transmitted training course file with any other encrypted so transmitted training course files of the predetermined training course to provide an authoring client retrievable file which can only be used in any manner after decryption using the encrypting key, disposed within the at least one computer, thus assuring that the assembled file can only be used as training course material via the remote server by only the authoring client.

33. The method according to claim 27 further comprising a step of using SSL public/private key encrypted transmission for all communications between the authoring client and remote server.

34. The method according to claim 27 comprising the steps of requesting and receiving from the remote server and, then, decrypting within a computer having the encrypting key, for testing and editing purposes, a contemporarily assembled portion of a training course.

35. The method according to claim 27 comprising a step of doubly decrypting received data to decode files encrypted by both the secure encrypting/decrypting key set defining program and as an SSL public/private encrypted transmission.

36. Apparatus for developing, releasing and distributing training courses via the Internet, whereby a client, who authors the courses, is assured release control and secure confidentiality of all contents of the courses prior to authorized course release by the client and whereby a service provider who distributes the training courses is assured selective control whereby the training courses can only be made available over the Internet by the service provider, said apparatus comprising:
a) at least one computer having a browser and an Internet link for use by the authoring client;
b) a server which comprises a centrally disposed link for communicating through the Internet link with the at least one computer for the purpose of receiving training course development material from the at least one computer;
c) an application service provider connection between the at least one computer and the server;
d) a server software package comprising applets, plug-ins and other programs for reconfiguring the browser to provide a training course authoring tool on the at least one computer for use by the authoring client;
e) said server software package further comprising software for defining a secure encrypting/decrypting key set and an associated encrypting program which encodes training course material composed by the authoring client to provide a secure encrypted file of all such course material sent to the server; and
f) training course material file storage disposed within said server for storing encrypted files of training course material received from the at least one computer, the encrypted files only being able to be decrypted by the at least one computer while the browser is reconfigured as a training course authoring tool and the encrypting key resides in the at least one computer.

37. Apparatus for developing, releasing and distributing training courses via the Internet according to claim 36 wherein said server comprises an assembler for assembling a plurality of encrypted training course material files into a single encrypted training course file.

38. Apparatus for developing, releasing and distributing training courses via the Internet according to claim 36 wherein said connection comprises an Internet connection.

39. Apparatus for developing, releasing and distributing training courses via the Internet according to claim 38 wherein said server is a remote server and said connection is a direct connection to said at least one computer.

40. Apparatus for developing, releasing and distributing training courses via the Internet according to claim 39 wherein said remote server comprises an Internet connection to a centrally disposed server.

41. Apparatus for developing, releasing and distributing training courses via the Internet according to claim 36 wherein said at least one computer is at least two computers.

42. Apparatus for developing, releasing and distributing training courses via the Internet according to claim 41 wherein said software for defining an encrypting key provides a tool shed and access to files addressed via the tool shed.

43. Apparatus for developing, releasing and distributing training courses via the Internet according to claim 36 wherein said server software package further comprises software for defining authoring keys for the tool shed whereby a part of the training course material created by a predetermined author is selectively only edited by an author having the authoring key.

44. Apparatus for developing, releasing and distributing training courses via the Internet according to claim 36 wherein said software package comprises a tool shed access program whereby a set of authoring keys are stored within the server to permit authorized access to tool shed and other program development material.

45. Apparatus for developing, releasing and distributing training courses via the Internet according to claim 36 wherein said software package comprises an encrypting key transfer program whereby the secure encrypting/decrypting key set is transmitted to the server to decrypt the training course file for release and selective distribution over the Internet to student clients.

46. Apparatus for developing, releasing and distributing training courses via the Internet according to claim 36 further comprising at least one computer having a browser and a communicating link for use by a student client in making a certification testing file associated with the training course.

47. Apparatus for developing, releasing and distributing training courses via the Internet according to claim 36
wherein said connection comprises an Internet connection.

48. Apparatus for developing, releasing and distributing training courses via the Internet according to claim 36 wherein said server is a remote server and said connection is a direct connection to said at least one computer.

49. Apparatus for developing, releasing and distributing training courses via the Internet according to claim 48 wherein said remote server comprises an Internet connection to a centrally disposed server.
